(19) United States
(12) Patent Application Publication
(10) Pub. No.: US 2022/0006922 A1
(43) Pub. Date: Jan. 6, 2022

(54) COORDINATED MULTI-VIEWPOINT IMAGE CAPTURE

(71) Applicant: QUALCOMM Incorporated, San Diego, CA (US)

(72) Inventors: Jayesh BATHIJA, San Diego, CA (US); Taoufik Tani, San Diego, CA (US); Ning Bi, San Diego, CA (US)

(21) Appl. No.: 16/920,219

(22) Filed: Jul. 2, 2020

(51) Int. Cl. H04N 5/073; H04N 5/232; H04N 5/225

(52) U.S. Cl. CPC H04N 5/0733; H04N 5/2256; H04N 5/23206

(57) ABSTRACT

Various embodiments may include methods and systems for configuring synchronous multipoint photography. Various embodiments may include displaying preview images on initiating and responding devices. Various embodiments may include determining an adjustment to the orientation of a responding device based on the preview images. Various embodiments may include transmitting an instruction configured to enable the responding device to display a notification for adjusting the position or the orientation of the responding device based at least on the adjustment. Various embodiments may include transmitting, to the responding device, a second instruction to enable the responding device to capture a second image at approximately the same time as the initiating device captures a first image. Embodiments further include capturing, via a camera, the first image, receiving, from the responding device, s second image, and generating an image file based on the first image and the second image.

### BACKGROUND

Standard wireless device photos are taken from a single perspective and are two-dimensional. A user may capture multiple images of a subject from different points of view, but each additional image captured will have been at a time after a first image capture. This is problematic when attempting to take a three-dimensional (3D) portrait of a subject if the subject has moved between images.

Methods of capturing 3D images using two or more cameras that are fixed and configured to take images of a same subject simultaneously, providing images that can be stitched together to create the 3D image. However, this requires fixing the cameras in pre-set positions (e.g., around a football field). Thus, it is not possible today to take synchronous 3D images using multiple handheld cameras or unmanned aerial vehicles or drones equipped with cameras.

### SUMMARY

Various aspects include methods and circuits for performing synchronous multi-viewpoint photography using handheld cameras and computing devices including cameras, such as smartphones. Various aspects performed on an initiating wireless device may include

transmitting, to a responding device, a first instruction configured to enable the responding device to display a notification for adjusting a position or an orientation of the responding device, transmitting, to the responding device, a second instruction configured to enable the responding device to capture a second image at approximately the same time as the initiating device captures a first image, capturing the first image, receiving, from the responding device, the second image, and generating an image file based on the first image and the second image.

In some aspects, transmitting a second instruction configured to enable the responding device to capture a second image at approximately the same time as the initiating device captures a first image may include, transmitting a timing signal that enables synchronizing a clock in the initiating device with a clock in the responding device, and transmitting a time based on the synchronized clocks at which the first and second images will be captured. In some aspects, transmitting a second instruction configured to enable the responding device to capture a second image at approximately the same time as the initiating device captures a first image may include instructing the responding device to capture a plurality of images and recording a time when each image is captured, capturing the first image may include capturing the first image and recording a time when the first image was captured, receiving the second image may include transmitting, to the responding device, the time when the first image was captured and receiving the second image in response, in which the second image is one of the plurality of images that was captured by the responding device at approximately the time when the first image was captured.

In some aspects, transmitting a second instruction configured to enable the responding device to capture a second image at approximately the same time as the initiating device captures a first image may include, transmitting an instruction to start one of a countdown timer or a count up timer in the responding device at a same time as a similar count down or count up timer is started in the initiating device, in which the instruction informs the responding device to capture the second image upon expiration of the countdown timer or upon the count up timer reaching a defined value, in which capturing the first image is performed upon expiration of the countdown timer or upon the count up timer reaching the defined value.

Some aspects may further include receiving a time signal from a global positioning system (GPS), in which transmitting the second instruction configured to enable the responding device to capture a second image at approximately the same time as the initiating device captures a first image may include indicating a time based on GPS time signals at which the responding device should capture the second image.

Some aspects may further include capturing a third image, storing a third time value when the third image is captured, transmitting the third time value to the responding device, receiving, from the responding device, a fourth image corresponding to the third time value, and generating the multi-image file based on the third image and the fourth image received from responding device.

Some aspects may further include generating an analog signal configured to enable the responding device to capture the second image at approximately the same time as the initiating device captures the first image, in which the analog signal is a camera flash or an audio frequency signal, in which capturing the first image is performed a predefined time after generating the analog signal.

In some aspects, the second instruction is further configured to enable the responding device to generate a camera flash and capture the second image at approximately the same time as the initiating device generates a camera flash and captures the first image.

Further aspects performed by a processor of a responding device for synchronous multi-viewpoint photography may include receiving, from an initiating device, an instruction configured to enable the responding device to capture an image at approximately the same time as the initiating device captures a first image, capturing an image at a time based upon the received instruction, and transmitting the image to the initiating device.

In some aspects, receiving an instruction configured to enable the responding device to capture an image at approximately the same time as the initiating device captures a first image may include, receiving a timing signal that enables synchronizing a clock in the responding device with a clock in the initiating device, and receiving a time based on the synchronized clocks at which the first and second images will be captured, in which capturing the image at a time based upon the received instruction may include capturing the image at the received time based on the synchronized clock.

Some aspects may further include receiving an instruction configured to enable the responding device to capture an image at approximately the same time as the initiating device captures a first image may include receiving an instruction to capture a plurality of images and recording a time when each image is captured, capturing the image may include, capturing the plurality of images at a time determined based on the received instruction, and storing time values when each of the plurality of images was captured, and transmitting the image to the initiating device may include, receiving a time value from the initiating device, and transmitting at least one image to the initiating device that was captured at or near the received time value.

In some aspects, receiving an instruction configured to enable the responding device to capture an image at approximately the same time as the initiating device captures a first image may include, receiving an instruction to start one of a countdown timer or a count up timer in the responding device at a same time as a similar count down or count up timer is started in the initiating device, in which capturing the image is performed upon expiration of the countdown timer or upon the count up timer reaching a defined value.

In some aspects, receiving an instruction configured to enable the responding device to capture an image at approximately the same time as the initiating device captures a first image may include, receiving an instruction to capture the image at a time based upon a GPS time signal.

In some aspects, receiving an instruction configured to enable the responding device to capture an image at approximately the same time as the initiating device captures a first image may include detecting an analog signal generated by the initiating device, in which the analog signal is a camera flash or an audio frequency signal, and capturing the image is performed in response to detecting the analog signal.

In some aspects, receiving an instruction configured to enable the responding device to capture an image at approximately the same time as the initiating device captures a first image may include receiving an instruction configured to enable the responding device to generate an illumination flash at approximately the same time as the initiating device generates an illumination flash, the method may include generating an illumination flash based upon the instruction when capturing the image.

Further aspects may include a wireless device having a processor configured to perform operations of any of the methods summarized above. Further aspects may include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a system block diagram illustrating an example communications system 100 according to various embodiments.

FIG. 2 is a component block diagram illustrating an example computing system suitable for implementing various embodiments.

FIG. 3 is a component block diagram illustrating an example system 300 configured for performing synchronous multi-viewpoint photography according to various embodiments.

FIG. 4 is a message flow diagram 400 illustrating operations and device-to-device communications for implementing various embodiments.

FIG. 5 illustrates a device-to-device system 500 for performing synchronous 3D multi-viewpoint photography according to some embodiments.

FIG. 6 illustrates an initiating device 600 for performing synchronous multi-viewpoint photography according to some embodiments.

FIG. 7 illustrates a device-to-device system 700 for performing synchronous multi-viewpoint photography prior to orientation adjustment according to some embodiments.

FIG. 8 illustrates a responding device 800 for performing synchronous multi-viewpoint photography according to some embodiments.

FIG. 9 illustrates a device-to-device system 900 for performing synchronous multi-viewpoint photography after orientation adjustment according to some embodiments.

FIG. 10 illustrates a responding device 1000 for performing synchronous multi-viewpoint photography according to some embodiments.

FIGS. 11-14 illustrate an initiating device and responding device for performing synchronous multi-viewpoint photography according to some embodiments.

FIG. 15 illustrates a device-to-device system 1500 for performing 360-degree 3D synchronous multi-viewpoint photography according to some embodiments.

FIGS. 16-20 illustrate an initiating device planning interface for performing synchronous multi-viewpoint photography according to some embodiments.

FIG. 21 illustrates a device-to-device system 2100 for performing synchronous panoramic multi-viewpoint photography according to some embodiments.

FIG. 22 illustrates a device-to-device system for performing synchronous panoramic multi-viewpoint photography according to some embodiments.

FIG. 23 illustrates initiating device and responding device camera view angles for performing synchronous panoramic multi-viewpoint photography according to some embodiments.

FIG. 24 illustrates an initiating device for performing synchronous panoramic multi-viewpoint photography according to some embodiments.

FIGS. 25-28 illustrate a progression of adjusting orientation parameters of a responding device for performing synchronous panoramic multi-viewpoint photography according to some embodiments.

FIG. 29 illustrates a device-to-device system 2900 for performing 360-degree synchronous panoramic multi-viewpoint photography according to some embodiments.

FIG. 30 illustrates a device-to-device system 3000 for performing synchronous multi-viewpoint photography having a blur effect according to some embodiments.

FIG. 31 illustrates a device-to-device system 3100 for performing synchronous multi-viewpoint photography according to some embodiments.

FIGS. 32-34 illustrate an initiating device for performing synchronous multi-viewpoint photography according to some embodiments.

FIG. 35 is a process flow diagram illustrating a method 3500 for an initiating device to perform synchronous multi-viewpoint photography according to some embodiments.

FIG. 36 is a process flow diagram illustrating alternative operations that may be performed by a processor of a wireless device as part of the method 3500 for performing synchronous multi-viewpoint photography according to some embodiments.

FIG. 37 is a process flow diagram illustrating a method 3700 implementing a responding device to perform synchronous multi-viewpoint photography according to various embodiments.

FIG. 38 is a process flow diagram illustrating alternative operations that may be performed by a processor of a wireless device as part of the method 3700 for performing synchronous multi-viewpoint photography according to some embodiments.

FIG. 39 is a process flow diagram illustrating a method 3900 for an initiating device to perform synchronous multi-viewpoint photography according to some embodiments.

FIG. 40 is a process flow diagram illustrating alternative operations that may be performed by a processor of a wireless device as part of the method 3900 for performing synchronous multi-viewpoint photography according to some embodiments.

FIG. 41 is a process flow diagram illustrating alternative operations that may be performed by a processor of a wireless device as part of the method 3900 for performing synchronous multi-viewpoint photography according to some embodiments.

FIG. 42 is a process flow diagram illustrating alternative operations that may be performed by a processor of a wireless device as part of the method 3900 for performing synchronous multi-viewpoint photography according to some embodiments.

FIG. 43 is a process flow diagram illustrating alternative operations that may be performed by a processor of a wireless device as part of the method 3900 for performing synchronous multi-viewpoint photography according to some embodiments.

FIG. 44 is a process flow diagram illustrating alternative operations that may be performed by a processor of a wireless device as part of the method 3900 for performing synchronous multi-viewpoint photography according to some embodiments.

FIG. 45 is a process flow diagram illustrating a method 4500 implementing a responding device to perform synchronous multi-viewpoint photography according to various embodiments.

FIG. 46 is a process flow diagram illustrating alternative operations that may be performed by a processor of a wireless device as part of the method 4500 for performing synchronous multi-viewpoint photography according to some embodiments.

FIG. 47 is a process flow diagram illustrating alternative operations that may be performed by a processor of a wireless as part of the method 4500 for performing synchronous multi-viewpoint photography according to some embodiments.

FIG. 48 is a process flow diagram illustrating alternative operations that may be performed by a processor of a wireless device as part of the method 4500 for performing synchronous multi-viewpoint photography according to some embodiments.

FIG. 49 is a process flow diagram illustrating alternative operations that may be performed by a processor of a wireless as part of the method 4500 for performing synchronous multi-viewpoint photography according to some embodiments.

FIG. 50 is a component block diagram of an example wireless device suitable for implementing various embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various embodiments include methods, and devices configured to implement the methods, for performing synchronous multi-viewpoint photography using handheld camera-equipped wireless devices, such as smartphones and robotic vehicles. Various embodiments may be configured to perform synchronous multi-viewpoint photography by synchronously capturing one or more images using an initiating device communicating with one or more responding devices. The captured images may be associated with timestamps for purposes of correlating the images to generate multi-viewpoint images and videos. The resulting multi-viewpoint images may include three-dimensional (3D), panoramic, blur or time lapse, multi-viewpoint, 360-degree 3D, and 360-degree panoramic images and image files.

The term “wireless device” is used herein to refer to any one or all of cellular telephones, smartphones, portable computing devices, personal or mobile multi-media players, laptop computers, tablet computers, smartbooks, ultrabooks, wireless electronic mail receivers, multimedia Internet-enabled cellular telephones, smart glasses, and similar electronic devices that include a memory, a camera, wireless communication components, a user display, and a programmable processor. The term “initiating device” is used herein to refer to a wireless device that is used to initiate and coordinate the operations of one or more other wireless devices to capture images for simultaneous multi-viewpoint photography by performing operations over various embodiments described herein. The term “responding device” is used herein to refer to a wireless device that receives information and commands from the initiating device and performs operations of various embodiments to participate in capturing images for simultaneous multi-viewpoint photography in coordination with the initiating device.

The term “system-on-a-chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system-in-a-package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

Various embodiments include methods for coordinating multi-viewpoint imaging of a subject (referred to herein as a “point of interest”) or scene from a number of perspectives in a single moment by multiple wireless devices equipped with cameras, such as smartphones and robotic vehicles devices, such as unmanned aerial vehicle (UAV) devices. Various embodiments may enable generating 3D-like photography using multiple images of a subject or scene, which is sometimes referred to herein as a point of interest, captured by a number of camera-equipped wireless devices at approximately the same time. The wireless devices and robotic vehicles (e.g., UAVs) may be configured to enable users of responding wireless devices to coordinate or reorient the location, orientation, and/or camera settings of camera-equipped wireless devices to achieve a desired multi-camera multi-viewpoint image or images. For example, in some embodiments a responding wireless device may receive adjustment instructions from an initiating wireless device, and display prompts to enable a user to adjust the elevation, tilt angle, camera lens focal depth, camera zoom magnification, and distance from a point of interest of the wireless device to set up a desired multi-camera image or images.

In some embodiments, an initiating device may send adjustment instructions to responding devices that enables a user of the initiating device to select and focus on a subject or a point of interest, instruct users of the responding device(s) (including operators of responding robotic vehicles) on how to frame and focus on the same subject or point of interest from different perspectives, and then trigger all wireless devices to capture an image or images approximately simultaneously from the different perspectives. The multi-camera images captured in this manner may be combined and processed to create a variety of image products including, for example, a 3D-like image (e.g., 3D, “Freeview,” gif animation, live photo, etc.), a time-sensitive panoramic image, a simultaneous multi-view image or video, or other multi-perspective image medium.

In some embodiments, the initiating device may collect preview images from the one or more responding devices. The initiating device may use the collected images to determine how the responding devices should be repositioned or reoriented so as to capture images for simultaneous multi-viewpoint photography desired by the user of the initiating device (e.g., 3D photography, panoramic photography, multi-viewpoint photography, etc.). The initiating device may then send adjustment information messages to the one or more responding devices instructing the users/pilots on how to adjust the location, orientation, or camera features or settings of the responding devices to be prepared to capture the multi-viewpoint images.

Various embodiments may be understood by way of example process for obtaining images for simultaneous multi-viewpoint photography using a number of wireless devices (e.g., smartphones). Initially, users of each wireless device may open an application that implements operations of the various embodiments. The device users may select or configure one of the devices to be the initiating device while the remaining devices are configured to be responding devices. The initiating device and one or more responding devices may communicate in real time over a wireless connection (e.g., LTE-D, WiFi, Bluetooth, etc.).

To orient and focus the wireless devices on a particular subject or point of interest for simultaneous multi-viewpoint photography, the user of the initiating device may choose the photographic subject, such as by tapping on the screen or user display interface to focus the camera on the subject. The initiating device may then collect information (e.g., device location, camera settings, device/camera orientation, current focal point, distance from subject, accelerometer information, etc.) and preview images from the responding devices. Using the received information and preview images, initiating device may determine how each responding device should be repositioned and reoriented to focus on the same subject sufficient to enable capturing images for simultaneous multi-viewpoint photography. The initiating device may transmit adjustment information messages automatically to the responding devices showing or otherwise directing the users on how to reposition/reorient their devices. In some embodiments, the adjustment information to users may be displayed as an augmented reality overlay on the responding device screens. The adjustment information messages can include instructions to recommend the responding device users to adjust a distance, height, tilt angle, and or camera setting so each device establishes (i) a same distance from the subject in horizontal and vertical planes and (ii) the desired diversity in perspective (i.e. at varying degrees around the subject). In some embodiments, the specific adjustment information can be automatic based on depth-sensing, object recognition machine-learning, eye tracking, etc. When the wireless devices are camera-equipped robotic vehicles (e.g., UAVs), the adjustment information messages from the initiating robotic vehicle device (or robotic vehicle controller) may direct responding robotic vehicle devices (or robotic vehicle controllers/pilots) on how to reposition the UAVs in three-dimensional space.

While the responding devices are being manually or automatically repositioning/reorienting per the adjustment information messages, the initiating device may analyze received preview images from each of the responding devices to determine when the responding devices are in the proper orientations/locations/settings, and may alert the user when that is the case. For example, once orientation and position of the responding devices are in an acceptable range to acquire the desired images for simultaneous multi-viewpoint photography, a button or interface display may inform the user of the initiating device of a “ready” status of the responding device(s) (e.g., interface button appears as green/ready, displays notification message, etc.) indicating that the image or a series of images can be taken at any time. In response, the user of the initiating device may initiate the image capture process by hitting or selecting the button. In some embodiments, instead of waiting for the user of the initiating device to press a button or otherwise take the images for simultaneous multi-viewpoint photography, the initiating device may automatically initiate image capture by all of the wireless devices as soon as all devices are in the proper orientations/locations/settings to capture the an image (i.e. the ready status is achieved). If a position/orientation of one or more of the responding devices is altered before image capture may be initiated, then the ready status may change to a “not ready” status (e.g., button appears as red, image capture is no longer selectable) to inform the initiating devices and responding device(s) to readjust again.

In some embodiments, when the user of the initiating device pushes a button or selects a corresponding user display interface icon, or in response to achieving the “ready” state, the initiating device may transmit commands to the responding device(s) to cause the responding device(s) to capture images in a manner that enables an image from every wireless device to be captured at approximately the same time. This process may include operations to synchronize image capture among the participating wireless devices. In some embodiments, the initiating device may issue a command to processors of the responding device(s) to automatically capture images at a designated time. In some embodiments, the initiating device may issue a command to processors of the responding devices to begin capturing a burst of images and storing multiple images in a buffer associated with a time when each image was captured. Each of the wireless devices by store the images in memory. In embodiments in which responding devices capture births of images, the images may be stored in a cyclic buffer/local storage with corresponding timestamps. The initiating device may also store one or a set of images having timestamps or associated time tags/values. The timestamps may be based on precise timing information derived from an on-board local clock (e.g., crystal oscillator), which may be synchronized using time information from a global navigation satellite system (GNSS) receiver (e.g., a global positioning system (GPS) receiver), from wireless communication network timing, or from a remote server.

The responding devices may then transmit captured images to the initiating device. In embodiments in which the responding devices capture a burst of images, the initiating device may transmit to each of the responding devices a time at which the initiating device captured an image, and the responding devices may one or more images with a timestamp closest to the time received from the initiating device. For example, an initiating device may capture one image with a specific timestamp, each responding device may receive the timestamp of the master device image, and then each responding device may retrieve an image from the series of burst images within the cyclic buffer that has a timestamp closest to the initiating device image timestamp.

The responding devices may transmit the captured images to the initiating device, which may process the images to obtain the desired images for simultaneous multi-viewpoint photography using known image combination processing techniques. Alternatively, the initiating device may transmit captured and received images to a remote server for image processing. Alternatively, each of the initiating device in the responding devices may transmit the collected captured images directly to a remote server for image processing to create the multi-viewpoint rendering.

Various embodiments provide new functionality by enabling handheld wireless devices to capture near simultaneous multi-viewpoint images for use in generating 3D images, panoramic images and multi-viewpoint action images. While various embodiments are particularly useful for handheld wireless devices capturing images for simultaneous multi-viewpoint photography, the embodiments may also be useful for setting up and capturing images for simultaneous multi-viewpoint photography in which some wireless devices are positioned on stands or tripods as the embodiments provide tools for positioning and focusing each of the wireless devices engaged in capturing the images for simultaneous multi-viewpoint photography.

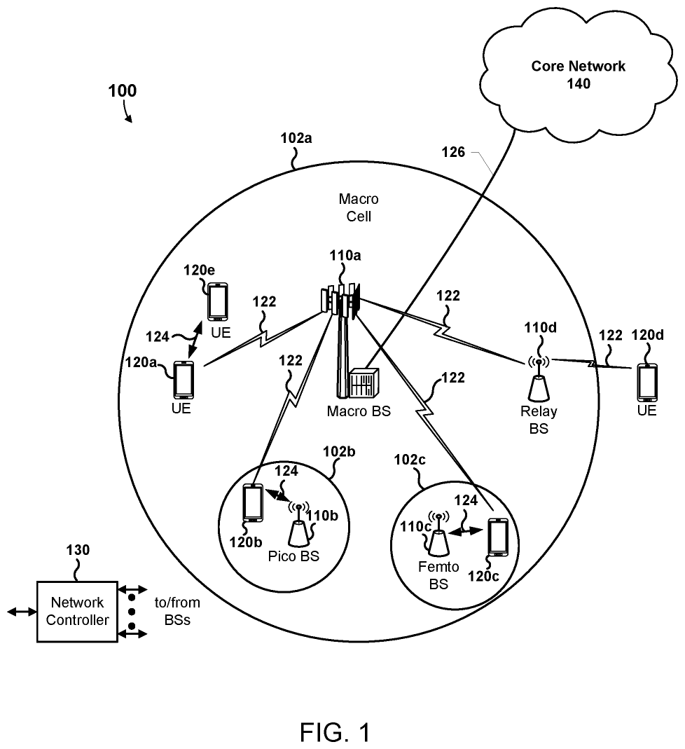

FIG. 1 is a system block diagram illustrating an example communications system 100 according to various embodiments. The communications system 100 may be an 5G NR network, or any other suitable network such as a Long Term Evolution (LTE) network.

The communications system 100 may include a heterogeneous network architecture that includes a communication network 140 and a variety of wireless devices (illustrated as wireless device 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

In some embodiments, timing information provided by a network server (e.g., communication network 140) may be used by the wireless devices to synchronization timers or clocks for purposes of synchronized image capture. A synchronization timer derived from the network server may be used for purposes of determining which images captured by the wireless devices should be correlated to form a multi-viewpoint image as described with respect to some embodiments.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In various embodiments examples, a cell may not be stationary, and the geographic area of the cell may move according to the location of a mobile base station. In various embodiments, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the communication network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay base station 110d may communicate with the macro base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communications system 100 include medium range protocols such as Wi-Fi, LTE-U, LTE-Direct, LAA, MuLTEfire, and relatively short-range RATs such as ZigBee, Bluetooth, and Bluetooth Low Energy (BLE).

Certain wireless networks (such as LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e. 6 resource blocks), and there may be 1, 2, 4, 8 or 16 subbands for system bandwidth of 1.25, 2.5, 5, 10 or 20 MHz, respectively.

In some implementations, two or more wireless devices 120a-e (for example, illustrated as the wireless device 120a and the wireless device 120e) may communicate directly using one or more sidelink channels 124 (for example, without using a base station 110 as an intermediary to communicate with one another).

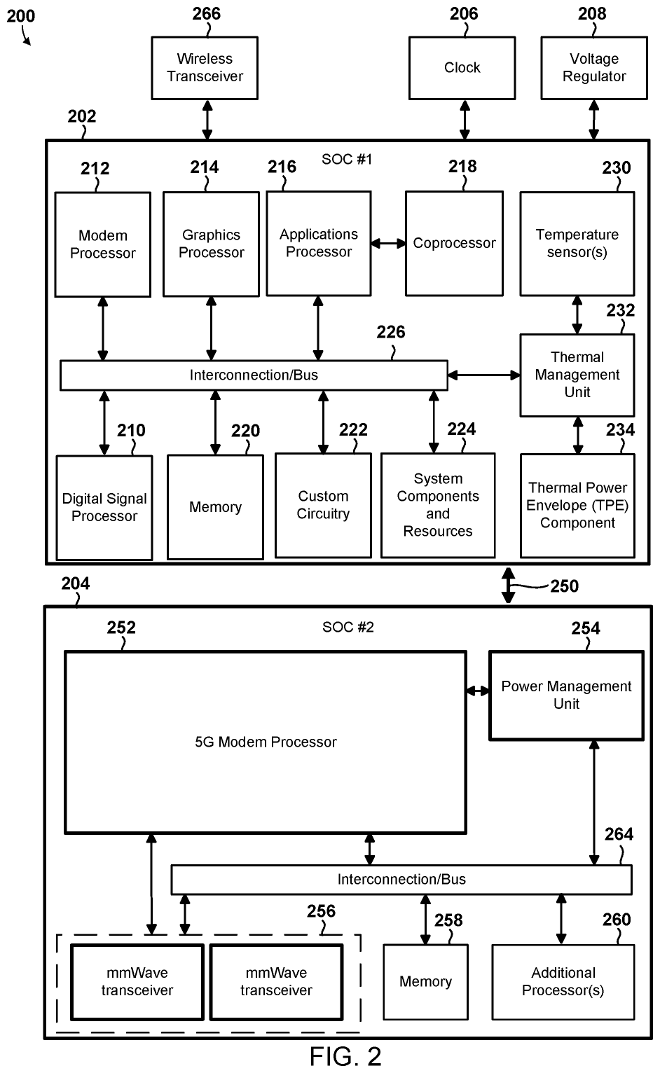

FIG. 2 is a component block diagram illustrating an example computing system on chip (SOC) or system in package (SIP) architecture that may be implemented within a wireless device and configured to perform operations of various embodiments.

With reference to FIGS. 1 and 2, the illustrated example SIP 200 includes a two SOCs 202, 204, a clock 206, a voltage regulator 208, and a wireless transceiver 266. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.). In some implementations, any or all of the processors 210, 212, 214, 216, 218, 252, 260 may be a component of a processing system. A processing system may generally refer to a system or series of machines or components that receives inputs and processes the inputs to produce a set of outputs (which may be passed to other systems or components of, for example, the first SOC 202 or the second SOC 250). For example, a processing system of the first SOC 202 or the second SOC 250 may refer to a system including the various other components or subcomponents of the first SOC 202 or the second SOC 250.

The processing system of the first SOC 202 or the second SOC 250 may interface with other components of the first SOC 202 or the second SOC 250, and may process information received from other components (such as inputs or signals), output information to other components, etc. For example, a chip or modem of the first SOC 202 or the second SOC 250 may include a processing system, a first interface to output information, and a second interface to receive information. In some cases, the first interface may refer to an interface between the processing system of the chip or modem and a transmitter, such that the first SOC 202 or the second SOC 250 may transmit information output from the chip or modem. In some cases, the second interface may refer to an interface between the processing system of the chip or modem and a receiver, such that the first SOC 202 or the second SOC 250 may receive information or signal inputs, and the information may be passed to the processing system. A person having ordinary skill in the art will readily recognize that the first interface also may receive information or signal inputs, and the second interface also may transmit information.

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, various implementations may be implemented in a wide variety of computing systems, which may include a single processor, multiple processors, multicore processors, or any combination thereof.

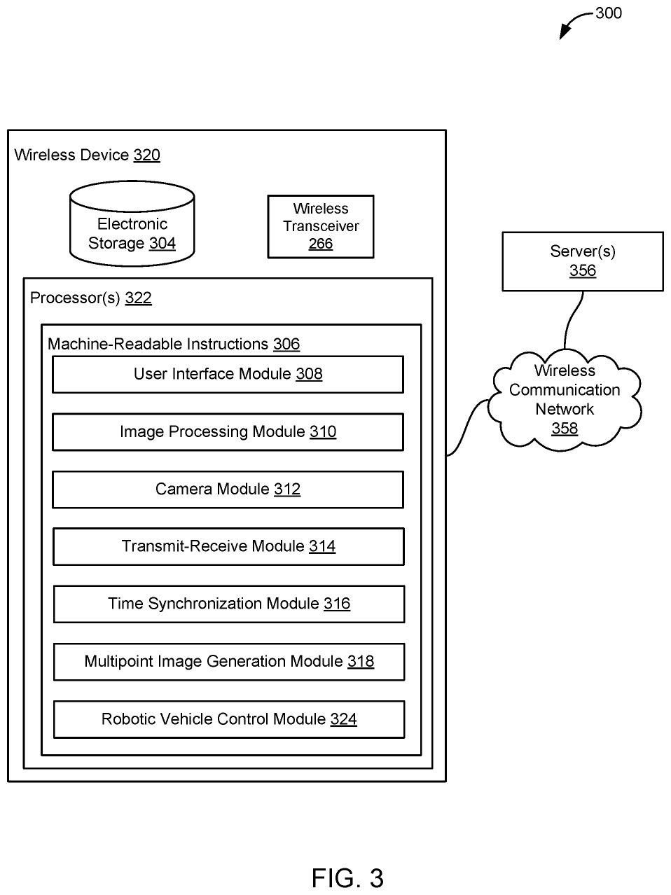

FIG. 3 is a component block diagram illustrating an example system 300 for performing synchronous multi-viewpoint photography according to various embodiments. With reference to FIGS. 1-3, the system 300 may include one or more wireless device(s) 120 (e.g., the wireless device(s) 120a-120e) and one or more server(s) 356, which may communicate via a wireless communication network 358.

The wireless device(s) 320 may be configured by machine-readable instructions 306. Machine-readable instructions 306 may include one or more instruction modules. The instruction modules may include computer program modules. The instruction modules may include one or more of a user interface module 308, an image processing module 310, a camera module 312, a transmit-receive module 314, a time synchronization module 316, a multi-viewpoint image generation module 318, and other instruction modules, such as a robotic vehicle control module 324 in some embodiments. The wireless device 320 may include electronic storage 304 that may be configured to store information related to functions implemented by the user interface module 308, the image processing module 310, the camera module 312, the transmit-receive module 314, the time synchronization module 316, the multi-viewpoint image generation module 318, and any other instruction modules, such as a robotic vehicle control module 324. The wireless device 320 may include processor(s) 322 configured to implement the machine-readable instructions 306 and corresponding modules. In some embodiments, the electronic storage 304 may include a cyclic buffer to store one or more images having timestamps at which the images were captured.

The user interface module 308 may be used to display and provide a user interface capable of being viewed and interacted with by a user of the wireless device 320. The user interface module 308 may receive selections, such as on a display screen, from a user. For example, the user interface module 308 may receive selections made by a user to identify a subject or point of interest within an image or image feed as rendered in the user interface by the camera module 312. In some embodiments, the user interface module 308 may display image feed information from other wireless devices, such as a real-time image feed received by the wireless device 320 from another wireless device.

The image processing module 310 may be used to process images rendered or captured by the camera module 312. The image processing module 310 may process images, such as preview images used for configuring a setup to perform synchronous multi-viewpoint image capture, or captured images to be used for generating multi-viewpoint image files. In some embodiments, the image processing module 310 may perform image processing on images, image feeds, or video files. In some embodiments, the image processing module 310 may process images to determine a subject or point of interest, or to determine location and/or orientation parameters of a subject or point of interest, such parameters including a size, height, width, elevation, shape, distance from camera or depth, and camera and/or device tilt angle in three dimensions.

The camera module 312 may be used to capture images for performing synchronous multi-viewpoint image generation. In some embodiments, the camera module 312 may relay or output a real-time image feed to a user interface for displaying the observed contents of the camera view angle to a user of the wireless device 320.

The transmit-receive module 314 may perform wireless communication protocol functions for communicating with various devices, including other wireless devices (e.g., an initiating device, responding device). The transmit-receive module 314 may transmit or receive instructions according to various embodiments. In some embodiments, the transmit-receive module 314 may transmit or receive time synchronization signals, clocks, instructions, or other information for purposes of synchronizing the wireless device 320 with one or more wireless devices.

The time synchronization module 316 may store a time synchronization signal for purposes of synchronizing the wireless device 320 with one or more wireless devices. The time synchronization module 316 may use the stored timer or clock signal to allocate a time value or timestamp to an image when an image is captured by the camera module 312. In some embodiments, the time synchronization module 316 may receive a time value or timestamp associated with one or more images captured by another wireless device to identify one or more images having time values or timestamps approximate to the received time value.

The multi-viewpoint image generation module 318 may generate one or more synchronous multi-viewpoint image files based on at least two images having different perspectives of a subject or a point of interest or multiple subjects or points of interest. The multi-viewpoint image generation module 318 may generate synchronous multi-viewpoint images using at least one image captured by the camera module 312 and at least one image received from at least one other wireless device. Depending on the image capture mode implemented by a user of the wireless device 320 or another wireless device, the image file generated by the multi-viewpoint image generation module 318 may have varying stylistic and/or perspective effects (e.g., 3D, panoramic, blur or time lapse, multi-viewpoint, 360-degree 3D, and 360-degree panoramic mode).

In embodiments in which a wireless device 320 is configured to work with camera-equipped robotic vehicles, a robotic vehicle control module 324 may be included that is configured perform operations to allow the wireless device 320 to maneuver and control the camera of a robotic vehicle (e.g., UAV) paired with the wireless device 320.

The wireless device 320 may be implemented as an initiating device and a responding device as described by embodiments. For example, the wireless device 320 may be utilized as an initiating device in one configuration or image capture event, and may also be utilized as a responding device in another configuration or image capture event occurring at a different time.

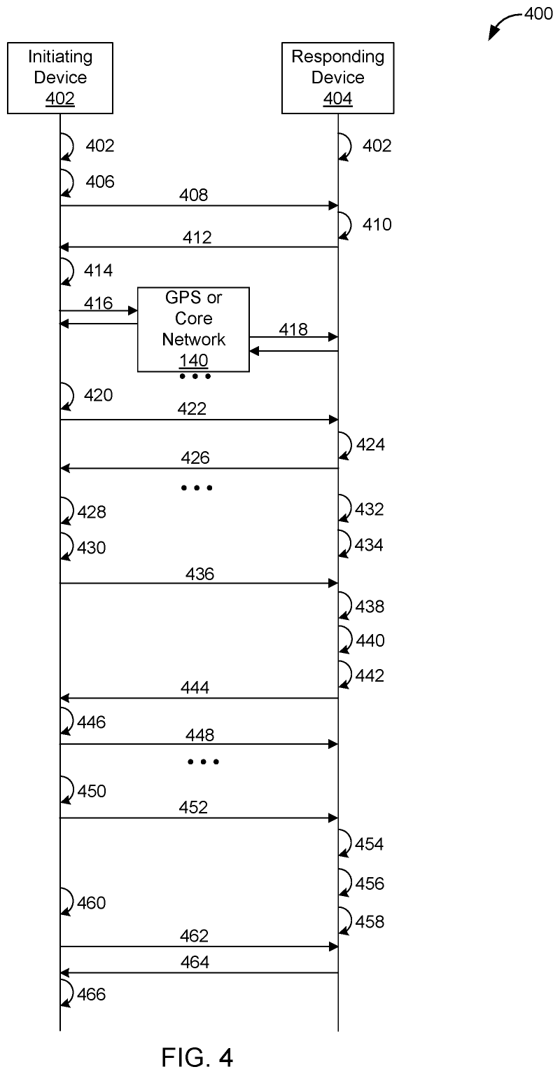

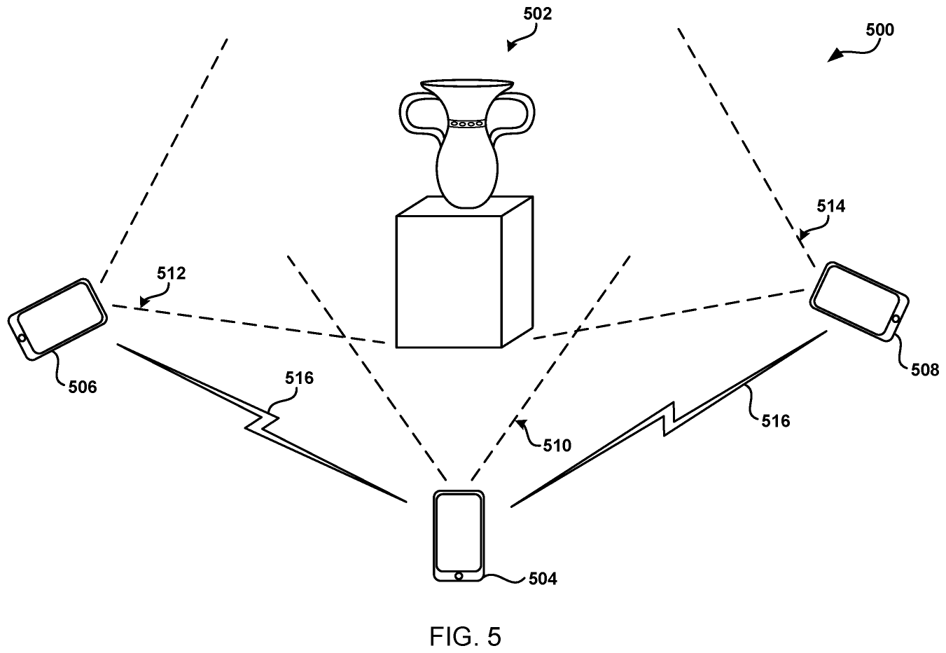

FIG. 4 is a message flow diagram 400 illustrating operations and device-to-device communications for performing synchronous multi-viewpoint photography according to some embodiments. The operations and communications for performing synchronous multi-viewpoint photography illustrated in FIG. 4 may be implemented using at least two wireless devices. For example, FIG. 5 illustrates an example 500 of three wireless devices 504, 506, 508 performing 3D multi-viewpoint photography of a point of interest 502 according to various embodiments. With reference to FIG. 1-5, the wireless devices 504, 506, and 508 may be oriented in such a way as to synchronously capture images to create a 3D rendering of the point of interest 502. The wireless devices 504, 506, and 508 have camera view angles 510, 512, and 514 respectively for synchronously capturing images of the point of interest 502. The wireless devices 504, 506, and 508 may present display interfaces that inform users of the wireless devices 504, 506, and 508 about how to align or adjust camera view angles 510, 512, and 514 with respect to the point of interest 502. The wireless devices 504, 506, and 508 may communicate using a device-to-device wireless communication links 516, and with the wireless device 508 via the wireless connection 518. The wireless connections 516 and 518 may be any form of close-range wireless communications protocols, such as LTE-D, LTE sidelink, WiFi, BT, BLE, or near field communication (NFC).

Synchronously capturing and collating multiple images as described with reference to FIGS. 4 and 5 may allow for the creation of a 3D image or video. For example, implementing the operations and communications as described with reference to FIG. 4 in the system illustrated in FIG. 5 may allow for the creation of a 3D image rendering of the point of interest 502, such that an image, gif, or video collated from multiple images taken by the wireless device 504, 506, and 508 may appear as if swiveling or rotating about the point of interest 502 in a single moment of time.

Referring to FIG. 4, in operation 402, an initiating device 402 may launch a multi-viewpoint image capture application. A user of the initiating device 402 may select a multi-viewpoint image capture application stored on the device or otherwise configure the initiating device 402 for performing synchronous multi-viewpoint photography.

In operation 404, a responding device 404 may launch a multi-viewpoint image capture application. A user of the responding device 404 may initiate a multi-viewpoint image capture application or otherwise configure the responding device 404 for performing synchronous multi-viewpoint photography.

In operation 406, the initiating device 402 may detect other devices within wireless communication range that have launched the multi-viewpoint image capture application or are otherwise configured for performing synchronous multi-viewpoint photography. For example, the initiating device 402 may include an interface displaying all wireless devices available for performing synchronous multi-viewpoint photography, and a user may select one or more available devices to establish device-to-device communications with.

In communication 408, the initiating device 402 may send a request to establish device-to-device wireless communications with the responding device 404. For example, as illustrated in FIG. 5, a user operating the wireless device 504 (e.g., initiating device 402) may see that the wireless device 506 (e.g., responding device 404) is available to establish device-to-device communications, and may select to pair or otherwise establish wireless communication links between the wireless devices 504 and 506. The wireless devices 504, 506, and 508 may be oriented in such a way as to synchronously capture images to create a 3D rendering of the point of interest 502. The wireless devices 504, 506, and 508 have camera view angles 510, 512, and 514 respectively for synchronously capturing images of the point of interest 502. The wireless devices 504, 506, and 508 may present display interfaces that inform users of the wireless devices 504, 506, and 508 about how to align or adjust camera view angles 510, 512, and 514 with respect to the point of interest 502. The wireless devices 504, 506, and 508 may communicate using a device-to-device wireless communication links 516, and with the wireless device 508 via the wireless connection 518. The wireless connections 516 and 518 may be any form of close-range wireless communications protocols, such as LTE-D, LTE sidelink, WiFi, BT, BLE, or NFC.

Referring again to FIG. 4, in response to the user initiating device-to-device communications, a processor of the initiating device 402 may transmit a request to establish device-to-device communications to the responding device 404. The request to establish communications between the initiating device 402 and the responding device 404 may be according wireless communications protocols such as LTE-D, LTE sidelink, WiFi, BT, BLE, and the like.

In response to receiving the request to establish device-to-device communications from the initiating device as described in communication 408, the responding device may display a notification to the user of the responding device during the user the option of accepting or declining the request to establish communications in operation 410.

In communication 412, the initiating device 402 may receive a confirmation to establish device-to-device wireless communications from the responding device 404. In response to receiving the confirmation from the responding device 404, the initiating device may begin the process of negotiating or otherwise creating a device-to-device connection (e.g., LTE-D, LTE sidelink, WiFi, BT, BLE, etc.) between the initiating device 402 and the responding device 404.

In operation 414, the initiating device 402 may receive a selection to operate as a controlling device. The user of the initiating device 402 may select, via a display interface of the initiating device 402, whether to assign control of the multi-viewpoint image capture process to the initiating device 402 in a master-slave configuration as opposed to the responding device. For purposes of this example, the initiating device 402 has been configured or otherwise selected to be the controlling device, hence being labeled an “initiating” device. In examples where the user of a first wireless device assigns or cedes control of the multi-viewpoint image process to another wireless device, then the first wireless device may transition from an “initiating” device into a “responding” device. Similarly, if a responding device is given control or the role of sending positioning and image capture instructions to other devices, the “responding” device may become the “initiating” device. In some embodiments, the responding device 404. The “initiating” device may control or signal when to initiate image capture and any “responding” device in wireless communication with the initiating device may begin image capture in response to the initiating device initiating image capture.

In some embodiments, operation 414 may be bypassed by configuring the initiating device 402 to be automatically set as the controlling device when sending a request to establish device-to-device communications as described in communication 410.

In communications 416 and 418, the initiating device 402 and the responding device 404 may individually request or obtain a synchronization timer or clock for purposes of synchronized image capture. Such time synchronization may be accomplish using various methods, including the initiating device announcing a current time on its internal clock, or the initiating device in responding device using an external time reference, such as a GNSS time signal or a network time signal, such as broadcast by base station of a communication network (e.g., 140). The synchronized clocks or a synchronization timer may be used in each of the participating wireless devices for purposes of capture of images by the initiating device 402 and the responding device 404 as described herein. The synchronization timer may be stored by both the initiating device 402 and the responding device 404. In some embodiments, time signals from a GNSS receiver may be used as a synchronized clock or reference clock.

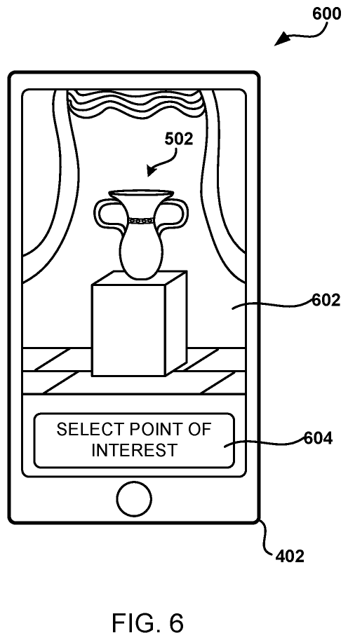

In operation 420, the initiating device 402 may display a preview image feed captured by a camera of the initiating device 402. The initiating device 402 may display the preview image feed in real time to a user via a user interface. For example, the initiating device 402 may display, through the multi-viewpoint image capture application or an existing camera application in communication with the multi-viewpoint image capture application, an image feed as captured by the camera of the initiating device 402. FIG. 6 illustrates an initiating device 600 displaying an example of a user interface display 602 including a point of interest 502 that may be presented on a display of the initiating device. A camera of the initiating device 402 may capture, in real time, a series of preview images or a preview image feed to output to the user interface display 602.

In communication 422, the initiating device 402 may transmit an image feed to the responding device 404. The real-time preview image feed captured by the camera of the initiating device 402 as described in operation 420 may be transmitted to the responding device 404 for use display to the user of the responding device so as to inform that user of the point of interest desired for multi-viewpoint photography. This may assist the user in initially pointing the responding device 404 at the point of interest. In some embodiments, the preview image or a series of preview images may be transmitted to the responding device 404 over a period of time to reduce the total data transmission amount as compared to transmitting an image feed in real time.

In operation 424, the responding device 404 may display a preview image feed captured by a camera of the responding device 404. The responding device 404 may display the preview image feed in real time to a user via a user interface. For example, the responding device 404 may display, through the multi-viewpoint image capture application or an existing camera application in communication with the multi-viewpoint image capture application, a preview image feed as captured by the camera of the responding device 404. FIG. 8 illustrates an example user interface display 800 of a responding device showing preview images captured by the camera of the responding device 402 when the cameras pointed at the point of interest 502.

In communication 426, the responding device 404 may transmit a preview image or image feed to the initiating device 402. The real-time image feed captured by the camera of the responding device 404 as described in operation 424 may be transmitted to the initiating device 402 for use in later operations (e.g., determining an adjustment to the orientation of the responding device 404 based on the responding device 404 image feed). In some embodiments, an image or a series of images may be transmitted to the initiating device 402 over a period of time to reduce the total data transmission amount as compared to transmitting an image feed in real time.

Operations 420 and 424 and communications 422 and 426 enabling the initiating and responding devices to share preview images may be repeated continuously throughout the processes described in FIG. 4.

In operation 428, the initiating device 402 may receive a user selection of a point of interest, or subject of interest, within the image feed. As illustrated in FIG. 6, a user of the initiating device 402 may be prompted by the user interface display 602 via an indicator 604 to begin selecting one or more points of interest 502. The user may select, via the user interface display 602, a point of interest according to conventional methods for identifying points of interest within a real-time image feed, such as interacting with a touch-screen to focus on an object at a depth or distance from the camera of the user device.

In operation 430, the initiating device 402 may determine location and/or orientation parameters of the initiating device 402. In some embodiments, the location and/or orientation parameters may be based on the user selection of the point of interest as described in operation 428. Location and/or orientation parameters of the initiating device 402 may include location, distance from the selected point of interest, camera settings such as zoom magnification, camera and/or device tilt angle, and elevation with respect to the selected point of interest. In some embodiments, location and/or orientation parameters may be based at least on image processing of the displayed image feed and/or an image captured by the camera of the initiating device 402. A location of the initiating device 402 may be determined by, or in any combination with, Global Navigation Satellite System (GNSS) satellite tracking and geolocation (e.g., via a Global Positioning System (GPS) receiver), WiFi and/or BT pinging, and accelerometers and gyroscopes. A distance between the initiating device 402 and the selected point of interest may be determined using image processing on the real-time image feed and/or on an image taken during the selection of the point of interest. For example, a real-world physical distance between the initiating device 402 and the selected point of interest may be determined by analyzing an apparent size of the point of interest within preview images, a lens focal depth, zoom magnification, and other camera settings. A tilt angle of the camera may be determined by accelerometers and gyroscopes within the camera module and/or initiating device 402 (assuming the camera is affixed to the initiating device 402), as well as image processing of preview images. An elevation of the camera and/or initiating device 402 may be determined by a combination of image processing (e.g., determining where the point of interest is located within a captured image frame of the camera view angle) and accelerometers and gyroscopes. In some embodiments, the initiating device 402 may implement image-processing techniques, such as depth-sensing, object recognition machine-learning, and eye-tracking technologies, to determine location and/or orientation parameters of the initiating device 402, with or without respect to a point of interest.

In operation 432, the responding device 404 may receive a user selection of a point of interest, or subject of interest, within the image feed. A user of the responding device 404 may be prompted by the user interface display to begin selecting one or more points of interest. The user may select a point of interest according to conventional methods for identifying points of interest within a real-time image feed, such as interacting with a touch-screen to focus on an object at a depth or distance from the camera of the user device.

After device-to-device communications have been established, the user of the responding device 404 and the user of the initiating device 402 may seek to simultaneously capture images focused on a point of interest, such that the captured images can be collated or combined to form 3D images, panoramic images, or temporally-related images (e.g., blurred images, time-lapsed images, multi-viewpoint image capture, etc.). For example, in operation 432, the user of the responding device 404 may select a point of interest similar to the point of interest selected by the user of the initiating device 402 as described in operation 428. FIGS. 6 and 8 illustrate examples of users of the initiating device 402 and the responding device 404 selecting or otherwise identifying the similar point of interest 502 for purposes of capturing multiple images from different viewpoints with respect to the point of interest 502.

In operation 434, the responding device 404 may determine location and/or orientation parameters of the responding device 404 based on the user selection of the point of interest as described in operation 432. Location and/or orientation parameters of the responding device 404 may include location, distance from the selected point of interest, camera settings such as zoom magnification, camera and/or device tilt angle, and elevation with respect to the selected point of interest. In some embodiments, location and/or orientation parameters may be based at least on image processing on the displayed image feed and/or an image captured by the camera of the responding device 404. A location of responding device 404 may be determined by, or in any combination with, GNSS satellite tracking and geolocation, WiFi and/or BT pinging, and accelerometers and gyroscopes. A distance between the responding device 404 and the selected point of interest may be determined using image processing on the real-time image feed and/or on an image taken during the selection of the point of interest. For example, a real-world physical distance between the responding device 404 and the selected point of interest may be determined by analyzing a lens focal depth, zoom magnification, and other camera settings. A tilt angle of the camera may be determined by accelerometers and gyroscopes within the camera module and/or responding device 404 (assuming the camera is affixed to the responding device 404), as well as image processing of preview images (e.g., to locate the point of interest within the field of view of preview images). An elevation of the camera and/or responding device 404 may be determined by a combination of image processing (e.g., determining where the point of interest is located within a captured image frame of the camera view angle) and accelerometers and gyroscopes.

Operations 428 through 434 may be repeated simultaneously and continuously throughout the processes described in FIG. 4. For example, points of interest may be selected, reselected, or otherwise adjusted, and location and/or orientation parameters may be continuously determined at any time with respect to the processes described in FIG. 4.

In communication 436, the initiating device 402 may transmit location and/or orientation adjustment information to the responding device 404. The location and/or orientation adjustment information may include information useable by the responding device 404 and/or the user of the responding device 404 to adjust a position and/or orientation of the responding device 404 and/or one or more features or settings of the responding device 404. The location and/or orientation information may be configured to enable the responding device 404 to display the location and/or orientation adjustment information on the user interface display (e.g., 802) of the responding device 404. The location and/or orientation information may include the location and orientation parameters of the initiating device 402 as determined in operation 430. In some embodiments, the location and/or orientation information may include a configuration image, such as an image captured during the selection of a point of interest as described in operation 428, or a real-time preview image feed or portions of a real-time image feed, such as described in communication 422.

In some embodiments, the location and/or orientation adjustment information may include commands to automatically execute adjustments to features or settings of the responding device 404. For example, the location and/or orientation adjustment information may include commands to automatically adjust a zoom magnification of the camera of the responding device 404 to be equivalent to the zoom magnification of the camera of the initiating device 402.

In operation 438, the responding device 404 may display the location and/or orientation adjustment information on a user interface display of the responding device 404. As described with reference to FIG. 8, the indicator 804 may display the location and/or orientation adjustment information to the user to adjust an orientation, setting, or feature of the responding device 404. For example, the location and/or orientation adjustment information may configure the indicator 804 to display messages to the user such as “move 1 meter closer,” “zoom in,” “tilt camera up,” “turn on flash,” “tilt camera sideways,” or any other message of varying specificity or degree for adjusting the physical location or orientation of the responding device and/or any feature of the camera.

In some embodiments, the responding device 404 may display a configuration image or real-time image feed of the initiating device. The user may reference the configuration image or real-time image feed to determine and perform adjustments to the orientation, features, or settings of the camera and/or responding device 404. For example, the user may determine, based on the visual reference of a real-time image feed, to move closer to the point of interest to be at a similar or equivalent distance from the point of interest as the initiating device 402.

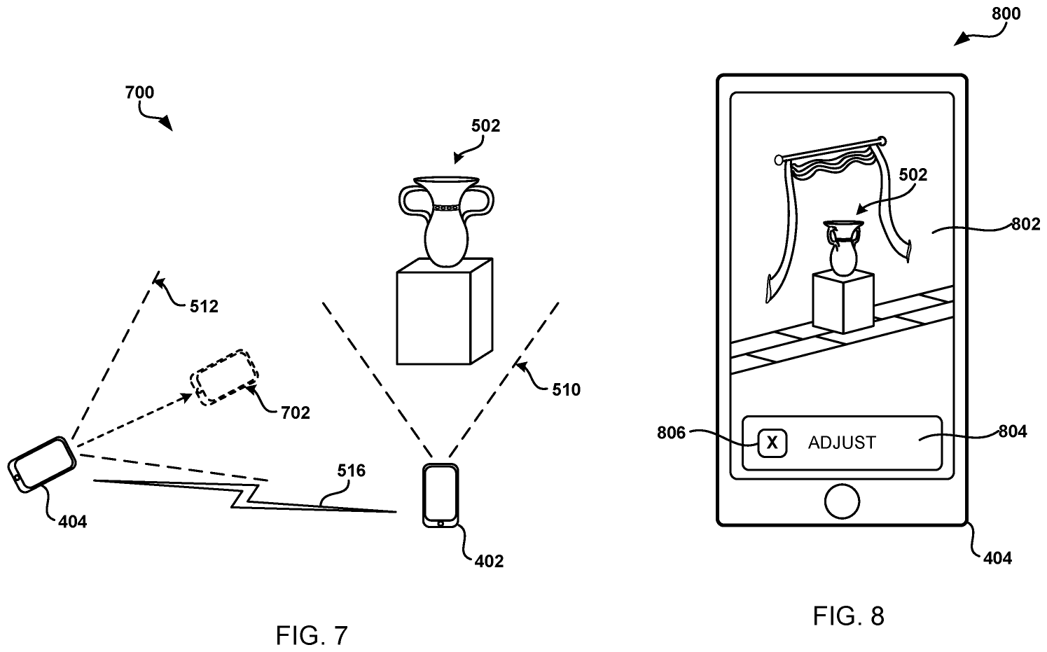

FIG. 7 illustrates an imaging set up 700 in which location and/or orientation adjustment information provided by the initiating device is displayed on the user interface of the responding device 404. In the illustrated example, the location and/or orientation adjustment information indicates that the user should move closer by a certain amount or distance to orient the responding device 404 into new location 702 having a distance from the point of interest 502 that is similar to the distance of the initiating device 402 from the point of interest 502.

Referring back to FIG. 4, in operation 440, a user of the responding device 404 may adjust the location and/or orientation of the responding device 404. In some embodiments in which the location and/or orientation adjustment information received from the initiating device 402 in communication 436 includes commands to automatically adjust features or settings of the responding device 404, the responding device may execute those commands. In some embodiments, the commands to adjust features or settings of the responding device 404 may be executed automatically upon receipt, or after the user of the responding device 404 approves the execution of the commands (e.g., via a prompt on the user interface display). For example, based on the received location and/or orientation adjustment information, the responding device 404 may automatically increase a zoom magnification setting of the camera to further focus on a point of interest.

In operation 442, the responding device 404 may determine current location and orientation parameters of the responding device 404. The responding device 404 may determine updated location and orientation parameters of the responding device 404 in response to any adjustments made during operation 440.

In communication 444, the responding device 404 may transmit the updated location and orientation parameters to the initiating device 402. The initiating device 402 may receive the updated location and orientation parameters of the responding device 404 for purposes of determining whether further adjustments to the location and/or orientation of the responding device 404 should be made prior to capturing images for multi-viewpoint image photography.

In some embodiments, the responding device 404 may transmit, along with the updated location and/or orientation parameters, a preview image or images, such as an image captured during the selection of a point of interest as described in operation 432, or a real-time preview image feed or portions of a real-time image feed, such as described in communication 426.

In operation 446, the initiating device 402 may determine whether the updated location and/or orientation parameters of the responding device 404 received in communication 444 correspond to the location and/or orientation adjustment information transmitted in communication 436. In other words, the initiating device 402 may determine whether the responding device 404 is “ready” to perform synchronous multi-viewpoint photography, such by determining whether the responding device 404 is at an appropriate location and orientation (e.g., elevation, tilt angle, camera settings and features, etc.). In some embodiments, operation 446 may involve comparing preview images of the initiating device with preview images received from the responding devices to determine whether the point of interest is similarly positioned and of a similar size in each of the device preview images. When the preview images are aligned, the collection of wireless devices may be ready to capture images for simultaneous multi-viewpoint photography of the point of interest.

The desired location and orientation of a responding device with respect to a point of interest and an initiating device may vary depending on the photography or video capture mode enabled. For example, a 3D image capture mode may indicate to the users of an initiating device and any number of responding devices to be at an equivalent distance from a point of interest and to have a same tilt angle. As another example, a panoramic image capture mode may indicate to the users of an initiating device and any number of responding devices to orient the devices in a linear manner with cameras facing a same direction (e.g., a horizon).

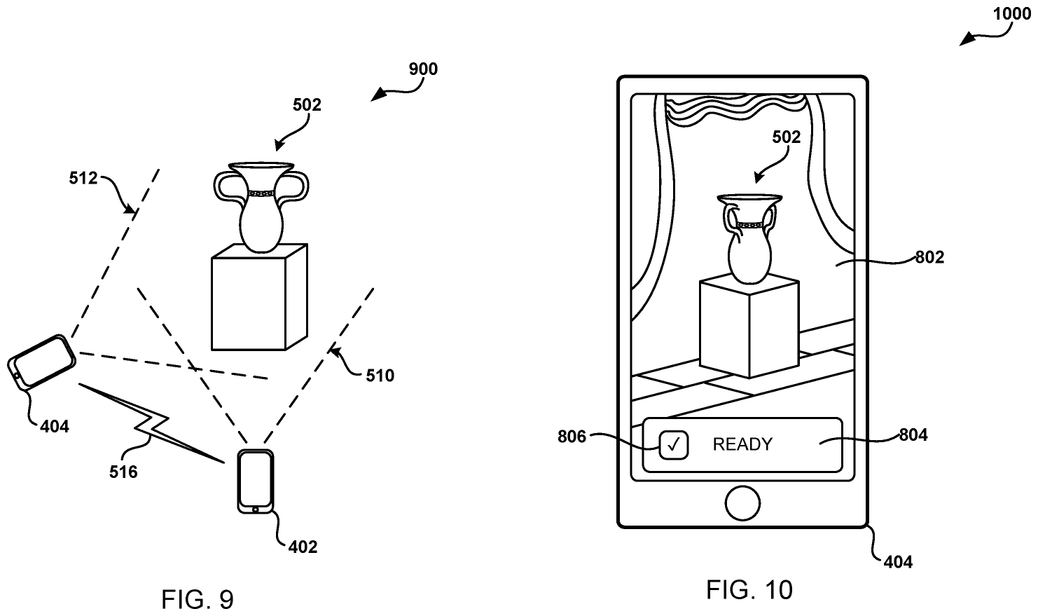

FIG. 9 illustrates an imaging set up 900 after the user of the responding device 404 has adjusted the position of the responding device 404 based on the adjustment instructions provided by the initiating device 402 as shown in FIG. 7. So positioned, the two wireless devices 402, 404 are at a similar distance from the point of interest 502, and so ready to capture a simultaneous multi view image of the point of interest.

Referring back to FIG. 4, in some embodiments, determining whether the updated location and/or orientation parameters of the responding device 404 received in communication 444 correspond to the orientation adjustment information transmitted in communication 436 may include determining whether the updated location and/or orientation parameters are within a threshold range of the orientation adjustment information. In some embodiments, this may involve determining whether the relative position of the point of interest in each of the preview images is within a threshold distance of each other sufficient so that the images can be processed to generate a suitable 3D image of the point of interest. For example, the initiating device 402 may determine that a responding device 404 is in a ready state if the camera tilt angle is at least within a threshold range of 5 degrees. As another example, the initiating device 402 may determine that a responding device 404 is in a ready state if within 0.25 meters of a desired location with respect to a point of interest. Image processing may be implemented after obtaining a preview image to account for any variance within a tolerable threshold range for the location and/or orientation parameters of any responding device.

If the initiating device 402 determines that the updated operating parameters of the responding device 404 do not correspond to the location and/or orientation adjustment information (i.e. the responding device 404 location and orientation vary too much from the orientation adjustment information) or the preview images of the various wireless devices are not suitably aligned, and is therefore the wireless devices are not “ready” two capture the images for simultaneous multi-viewpoint photography, the processes n communication 436, operations 438 through 442, and communication 444 may be repeated until the updated location and/or orientation parameters correspond to the location and/or orientation adjustment information or the various preview images lying within the threshold tolerance.

The initiating device 402 may compare location and/or orientation adjustment information with the updated location and/or orientation parameters received from the responding device 404 to determine updated location and/or orientation adjustment information. For example, as illustrated in FIG. 7, the user, based on the original location and/or orientation adjustment information received in communication 436, may relocate the responding device 404. However, the user may move past the location 702 to orient the responding device 404 too close to the point of interest 502 with respect to the location of the initiating device 402. As illustrated in FIG. 8, the responding device 404 indicator 806 would therefore not indicate a ready status. The initiating device 402 would then receive the latest location and/or orientation parameters or preview images of the responding device 404 in communication 444. The initiating device 402 may then determine that the received latest location and/or orientation parameters of the responding device 404 do not correspond to the location and/or orientation adjustment information or that the preview images do not align. Thus, the initiating device 402 may determine a difference between the latest location and/or orientation parameters of the responding device 404 and the last-transmitted location and/or orientation adjustment information. For example, the initiating device 402 may determine that the location and/or orientation parameters and the location and/or orientation adjustment information differ by −0.5 meters. Thus, the initiating device 402 may repeat processes described in communication 436 to transmit updated location and/or orientation adjustment information to the responding device 404 based on the last received location and/or orientation parameters of the responding device 404 to enable the user of the responding device 404 to readjust based on the updated location and/or orientation adjustment information. For example, the updated location and/or orientation adjustment information may include an instruction to configure the display 802 of the responding device to display to the user “move back 0.5 meters.”

In some embodiments, the initiating device 402 may display a configuration image or real-time preview image feed from the responding device 404. The user of the initiating device 402 may use the configuration image or real-time preview image feed to determine whether the responding device 404 is positioned to capture the desired images for simultaneous multi-viewpoint photography, and may then provide an indication to be transmit to the responding device to indicate the acknowledgment of a “ready” status. For example, the user of the initiating device 402 may determine, based on the visual reference of a configuration from the responding device 404, to determine that all devices are ready to begin image capture. This may be useful when performing synchronous multi-viewpoint photography in a multi-viewpoint mode involving multiple different points of interest.

If the initiating device 402 determines that the updated parameters of the responding device 404 correspond to the location and/or orientation adjustment information or that the multiple preview images online within a predetermined threshold difference, the initiating device may be permitted to begin the image capture process. Until processor determines that all of the wireless devices are appropriately positioned to capture the images for simultaneous multi-viewpoint photography, the initiating device 402 may be prevented from starting the image capture process. Until all wireless devices are ready, the initiating device 402 may display an indication that at least one connected responding device is not in a ready state, but may allow the initiating device to proceed regardless of the status of the responding devices.

Referring back to FIG. 4, in communication 448, the initiating device 402 may transmit an instruction to the responding device 404 to indicate that the updated location and/or orientation parameters of the responding device 404 received in communication 444 correspond to the location and/or orientation adjustment information transmitted in communication 436 (i.e., the responding device 404 is ready). As illustrated in FIG. 8, the indicator 806 may indicate that the responding device 404 is not in a ready status, indicating to the user that the location, orientation, and/or features or settings of the responding device 404 need to be adjusted. FIG. 10 illustrates a user interface display 1000 of a responding device showing an indicator 806 indicating that the responding device 404 is positioned so that the system of wireless devices is ready to capture the images for simultaneous multi-viewpoint photography. This may indicate to the user other responding device 404 that he/she should hold the wireless device steady at the location and orientation until the images captured. In some embodiments, the indicator 806 may indicate a default state of “not ready.” In some embodiments, a ready status as shown by indicator 806 may revert to a “not ready” status if the latest location and/or orientation parameters of the responding device 404 are altered to be outside the acceptable threshold range for conducting simultaneous multi-viewpoint photography as determined by the location and/or orientation adjustment information of the initiating device 402.

Referring back to FIG. 4, in operation 450, the initiating device 402 may receive a selection by the user to begin image capture. Operation 450 may be performed at any time after the responding device 404 is determined to be in a ready status by the initiating device 402. The user may select or press a button or virtual display button or icon to begin image capture.

In communication 452, the initiating device 402 may transmit, to the responding device 404 an instruction to begin image capture. The instruction may be configured to enable the camera of the responding device 404 to capture at least one image at approximately the same time that the camera of the initiating device 402 captures an image. In some embodiments, the instruction may include an initiate time value corresponding to the time that the user-initiated image capture as described in operation 450. In some embodiments, the initiate time value may be based on the time synchronization values received by the initiating device 402 and the responding device 404 as described in communications 416 and 418. The time synchronization values, as stored on the initiating device 402 and the responding device 404, may be used to identify and correlate images captured and stored within cyclic buffers within each device as described in later operations. In some embodiments, the initiate time value may be based on a local clock frequency of the initiating device 402.

In some embodiments, initiating image capture may automatically initiate generation of an analog signal for purposes of synching image capture. An analog signal may be generated and output by the initiating device 402 in place of communication 452 to initiate image capture. For example, the initiating device 402 may generate a flash via the camera flash or an audio frequency “chirp” via speakers to instruct the responding device 404 to begin image capture automatically. The responding device 404 may be configured to detect a flash or audio frequency “chirp” generated by the initiating device 402, and begin the process to capture at least one image in response to such detection. In some embodiments, a test analog signal may be generated to determine the time between generation of the analog signal and the time upon which the responding device 404 detects the analog signal. The determined analog latency may be used to offset when the responding device 404 should generate a camera flash for purposes of image capture and/or when the responding device 404 should capture an image.

In some embodiments, the instruction transmitted in communication 452 may include a delay value. The responding device 404 may be configured to display an indication to initiate or otherwise automatically initiate image capture after the duration of the delay value has passed. A delay value may reduce the amount of electronic storage used when capturing more than one image in a cyclic buffer, such that proceeding to capture images after a certain delay value may be closer to the point in time at which the initiating device begins capturing at least one image. The delay value may include a latency between the initiating device 402 and the responding device 404, in which the latency is caused by wireless communications protocols and handshaking and physical distance separating the devices. A delay value may include additional delay time in embodiments involving more than one responding device to account for the possibility that each responding device may have a different latency value for communications with the initiating device. For example, the delay value may be equal to at least the time value of the largest latency value among the involved responding devices. Thus, the automatic capture of images by each responding device may be offset by at least the difference between their individual time delays and the largest latency value among the responding devices.

In some embodiments, the delay value may be used to automatically and simultaneously generate a camera flash by the initiating device 402, the responding device 404, and any other responding devices. Automatically and simultaneously generating a camera flash may be useful in illuminating points of interest from multiple angles. For example, an initiating device and multiple responding devices may be used to create a 360-degree 3D image of a point of interest.

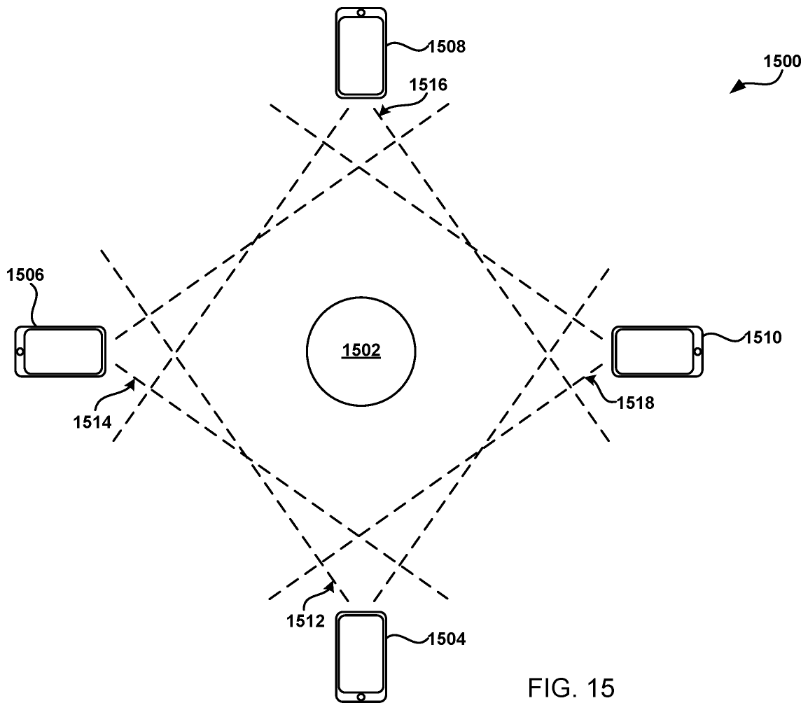

FIG. 15 illustrates a configuration 1500 in which four wireless devices are being used to capture a 360-degree 3D synchronous multi-viewpoint image. The four wireless devices 1504, 1506, 1508, and 1510 have camera view angles 1512, 1514, 1516, and 1518 respectively that will capture a full 360-degree synchronized image of the point of interest 1502. Using a delay value based at least on the latencies of the wireless communications links (not shown) between devices can allow the initiating device (e.g., wireless device 1504) to instruct all devices to generate a camera flash simultaneously. This may allow the point of interest 1502 to be fully illuminated with little to no shadow effects. In some embodiments, the simultaneous camera flashes may be initiated after detection of an analog signal, such as a flash or a frequency “chirp.”

In some embodiments, the instruction to begin image capture may include a command to be executed by the responding device 404, such as to display an indication on the user interface display of the responding device 404 to instruct the user to initiate image capture.

Referring back to FIG. 4, in operation 454, the responding device 404 may display an indication to the user of the responding device 404 to initiate image capture. Assuming automatic image capture in response to an instruction (e.g., instruction received from communication 452) or detected audio signal is not enabled in the responding device 404, the responding device 404 may display an indication for the user to select or otherwise initiate image capture. In some embodiments in which automatic image capture is enabled and does not require user input, a display to indicate that image capture has begun, is being performed, and/or has finished may be output to the user interface display of the responding device 404.

In operation 456, the responding device 404 may receive a selection by the user to begin image capture. Assuming automatic image capture in response to an instruction (e.g., instruction received from communication 452) or detected audio signal is not enabled in the responding device 404, the responding device 404 may receive a selection by the user via the user interface display to begin image capture. Operation 456 may be performed at any time after the responding device 404 is determined to be in a ready status by the initiating device 402. The user may select or press, through the multi-viewpoint image capture application or an existing camera application in communication with the multi-viewpoint image capture application, a button or virtual display button or icon to begin image capture.

In operation 458, the camera of the responding device 404 may begin capturing at least one image. In some embodiments, the responding device 404 may store an image, a burst of images, or video data, such as within a cyclic buffer. The cyclic buffer may assign a timestamp value to each image captured. The timestamp value may be based on the synchronization timer received by the responding device 404 as described in communication 418. The time stamp value may correspond to a timestamp value assigned to images captured by the initiating device 402 (i.e. in operation 460). For example, the timestamp value may be based on a universal timer or clock received or derived from a network server (e.g., communication network 140, GNSS time, etc.). In some embodiments, the time synchronization values, as stored on the initiating device 402 and the responding device 404, may be used to identify and correlate images captured and stored within the cyclic buffer. In some embodiments, the timestamp value may be based at least on a local clock frequency of the responding device 404.

In operation 460, the camera of the initiating device 402 may begin capturing at least one image. The initiating device 402 may begin image capture in response to receiving a selection by the user to begin image capture as described in operation 450. In some embodiments, the operation 460 may occur automatically some delay time amount after performing operation 450, such as a time amount roughly equivalent to the time to perform communication 454 and operation 458. The initiating device 402 may store an image, a burst of images, or video data within a cyclic buffer. The cyclic buffer may assign a timestamp value to each image captured. The timestamp value may be based on the synchronization timer received by the initiating device 402 as described in communication 416, in which the time stamp value may correspond to a timestamp value assigned to images captured by the responding device in operation 458. For example, the timestamp value may be based on a universal timer or clock received or derived from a network server (e.g., communication network 140, GNSS time, etc.). The time synchronization values, as stored on the initiating device 402 and the responding device 404, may be used to identify and correlate images captured and stored within the cyclic buffer. In some embodiments, the timestamp value may be based at least on a local clock frequency of the initiating device 402.

In some embodiments, the operations 458 and 460 may be initiated automatically after communication 448, bypassing operations 450, 454, 456, 458, 460 and communication 452. For example, upon determining that the location and/or orientation adjustment information corresponds to the location and/or orientation parameters received from the responding device 404, the initiating device 402 and the responding device 404 may begin capturing images without receiving further user input (e.g., operation 450 receiving a selection by the user to begin image capture).

In communication 462, the initiating device 402 may transmit a timestamp value associated with a captured image to the responding device 404. In some embodiments, the initiating device 402 may transmit multiple timestamp values associated with multiple captured images or frames within a video file. In some embodiments, a user of the initiating device 402 may select an image from the images captured within the cyclic buffer in operation 460, upon which the timestamp value associated with the selected image is transmitted to the responding device 404.

In communication 464, the responding device 404 may transmit one or more captured images having a timestamp value that is equal to or approximately equal to the timestamp value transmitted in communication 464. The responding device 404 may analyze the cyclic buffer to determine which captured images have a timestamp equivalent to or closest to the timestamp received from the initiating device 402. The image(s) determined by the responding device 404 to have a timestamp close or equal to the initiating device timestamp value may correspond to a same instance upon which the initiating device captured the image associated with the initiating device timestamp value.

In operation 466, the initiating device 402 may correlate the image(s) received from the responding device 404 in communication 464 with the image(s) captured in operation 460. For example, the initiating device 402 may correlate or otherwise process the images captured by the initiating device 402 and the responding device 404 to form a single image file having multiple viewpoints of one or more points of interest. For example, as described with reference to FIG. 5, images captured by initiating device 504 and responding devices 506 and 508 can be correlated to create a 3D image or video file that may display multiple view angles of point of interest 502 taken at a same time. The resulting correlated image file may be generated according to conventional image processing techniques to account for variance in the threshold location and/or orientation parameters of each device while capturing the images. The resulting correlated image file may be a “.gif” file, video file, or any other data file that may include more than one viewpoint or a series of image files. In some embodiments, the initiating device 402 may transmit the image(s) captured in operation 460 and the image(s) received in communication 464 to an external image processing device or application (e.g., network server, desktop computer, photography application, etc.).

The operations and communications illustrated FIG. 4 may be performed in an order different than shown in the figure. For example, the operations 416 and 418 may be performed in any order before operation 450. The operations and communications for performing synchronous multi-viewpoint photography may be performed by multiple wireless devices, and may be continuous and ongoing while other communications between wireless devices and/or servers are performed for performing synchronous multi-viewpoint photography.

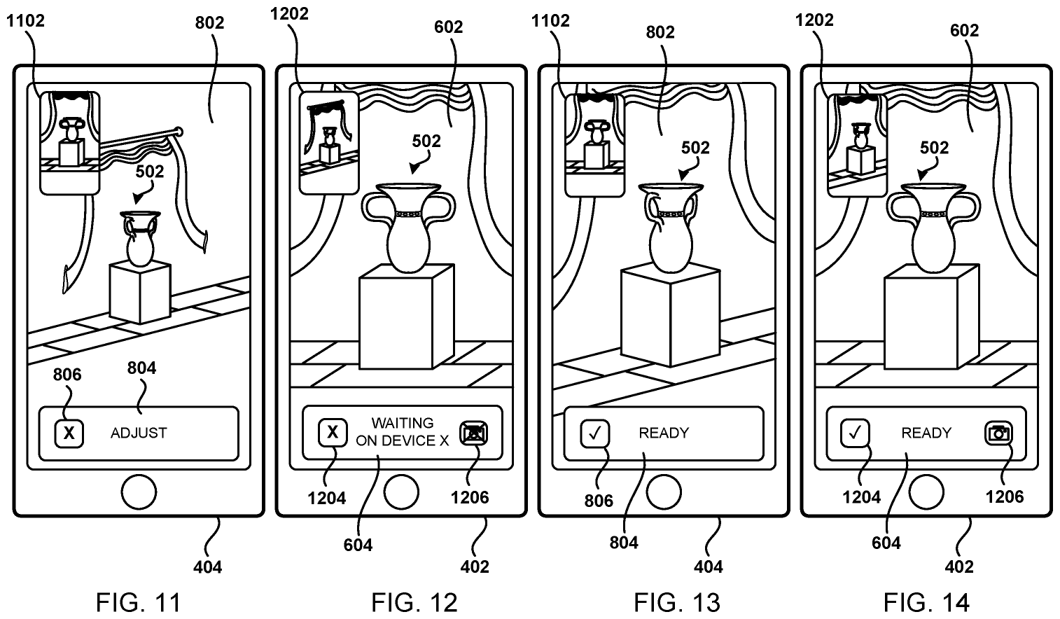

FIGS. 11-14 illustrate an initiating device and a responding device showing examples of user interface displays that may be implemented in various embodiments. FIG. 11 illustrates a responding device 404 and FIG. 12 illustrates an initiating device 402 showing examples of user interface displays while performing operations of synchronous multi-viewpoint photography according to some embodiments.

With reference to FIGS. 1-12, the initiating device 402 and responding device 404 are shown in FIGS. 11 and 12 in the “not ready” when the responding device is not yet achieved a position suitable for multi-viewpoint imaging. For example, the responding device 404 shows on the user interface display 802 that the point of interest 502 as identified by the initiating device 402 is not within a threshold perspective (e.g., the point of interest is too far away with respect to the camera of the responding device 404) to capture an image that can be correlated with an image captured by the initiating device 402.

As illustrated, the “not ready” status may be indicated on the user display interface 802 of responding device 404 by the indicator 806, and on the user display interface 602 of initiating device 402 by the indicator 1204 (e.g., depicted as an “X” for example). An indicator 804 may display a desired change in location and/or orientation of the responding device 404 to the user of the responding device 404. The desired change in orientation of the responding device may be based on current location and/or orientation parameters of the responding device 404 and location and/or orientation adjustment information received from the initiating device 402 as described. For example, the desired change in orientation may include displaying a message such as “move closer.”

An indicator 604 may display to the user of the initiating device 402 which, if any, responding devices (e.g., 404) are not in an appropriate location, not in an appropriate orientation, and/or not in an appropriate configuration setting four capturing multi-viewpoint imagery of the point of interest 502. In some embodiments, a “not ready” status may prevent the user from initiating image capture of the point of interest 502, or may cause the user interface display 602 to indicate that the user should not begin image capture (e.g., an image capture initialization icon 1206 is not selectable or dimmed).

In some embodiments, the user display interface of the responding device 404 may include a real-time preview image feed display 1102 of the camera view perspective of the initiating device 402. The user of the responding device 404 may utilize the real-time image feed display 1102, in addition to any message prompt displayed by the indicator 804, to adjust an orientation, location, or setting of the responding device 404. For example, the real-time image feed display 1102 may indicate to the user that the initiating device 402 is closer to the point of interest 502 than the responding device 404, and therefore the user should move the responding device 404 closer to the point of interest 502.

In some embodiments, the user display interface of the initiating device 402 may include a real-time preview image feed display 1202 of the camera view perspective of the responding device 404. The user of the initiating device 402 may utilize the real-time image feed display 1202, in addition to any message prompt displayed by the indicator 604, to determine whether the responding device 404 is close to a desired location or orientation. For example, the real-time image feed display 1202 may indicate to the user that the responding device 404 should be moved closer to the point of interest 502.

FIG. 13 illustrates a responding device 404 and FIG. 14 illustrates an initiating device 402 when the responding device 404 has moved to a position and orientation with respect to the point of interest such that the wireless devices are now “ready” two capture images for simultaneous multi-viewpoint photography. In the illustrated example, the real-time image feed displays 1102 and 1202 display a similar perspective of the point of interest 502, and the user interfaces 602 and 802 may display, via the indicators 604, 804, 806, and 1204, that the responding device 404 and the initiating device 402 are ready to begin image capture. Thus, the responding device 402 is at a location, in an orientation, and/or has appropriate features or settings to capture an image having a perspective that that may be combined or correlated with an image of the point of interest captured by the initiating device 402.

Once in a “ready” status, a user of the initiating device 402 may select or press the image capture initialization icon 1206 or otherwise use a button or feature of the initiating device 402 to begin capturing at least one image. In some embodiments, selecting or pressing the image capture initialization icon 1206 may cause the initiating device to transmit an instruction to the responding device 404. The instruction may configure the responding device 404 to begin capturing images at approximately the same time that the initiating device is capturing images. In some embodiments, the instruction may configure the responding device 404 to display (e.g., via the user interface display 802) an indication for the user of the responding device 404 to begin image capture.

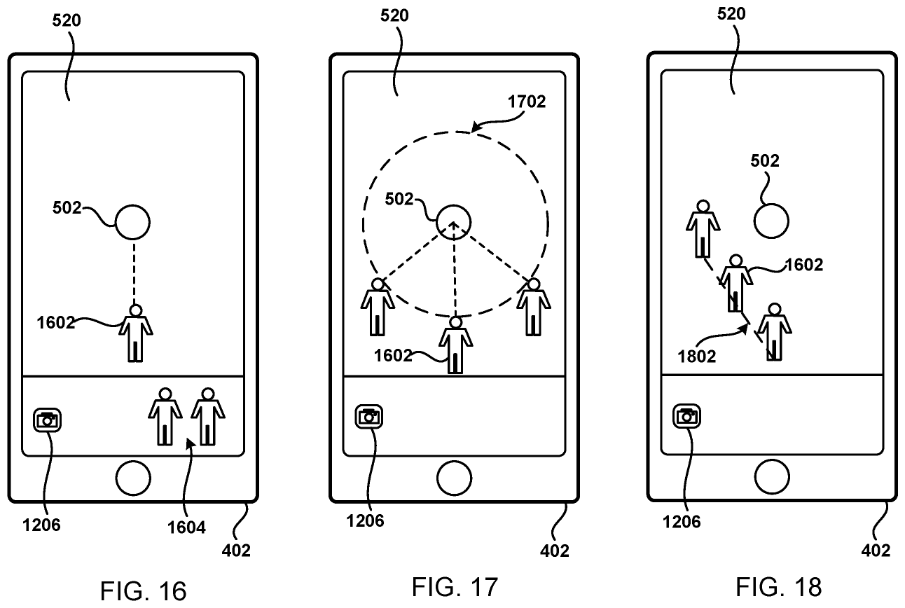

FIGS. 16-20 illustrate a planning user interface 520 that may be presented on a display of an initiating device 402 for performing synchronous multi-viewpoint photography according to some embodiments. With reference to FIGS. 1-20, an initiating device 402 may executing a multi-viewpoint image capture application may display the user interface that indicates desired locations or orientations of one or more responding devices to achieve successful multi-viewpoint imaging. The initiating device 402 may include a button or display icon with the user display interface 602 to allow a user to select and/or alternate between an image capture mode and planning mode. For example, an image capture mode may include a real-time image feed from a camera of the initiating device 402 as shown in the user display interface 602 in FIGS. 12 and 14. A planning mode may include an image capture mode icon to return to an image capture mode.

A planning mode may allow a user of the initiating device 402 to select a desired location and/or orientation of any responding device having active device-to-device communications with the initiating device 402. For example, as illustrated in FIG. 16, a user interface display 520 may include a user icon 1602 to indicate a location and orientation, including view angle and direction, of the initiating device 402 with respect to a point of interest 502 identified via image capture mode. A location and orientation of the initiating device 402, and consequently user icon 1602, may be based at least on lens focal depth with respect to the point of interest 502, where the lens focal depth is a current lens focal depth or a stored lens focal depth recorded at the time the point of interest 502 was identified in an image capture mode. The location and orientation of the initiating device 402 and user icon 1602 may be based at least on accelerometers, GNSS tracking, WiFi or BT/BLE pinging, or any other conventional geo-positioning hardware or software.

In some embodiments, a planning mode may be a bird's-eye, top-down view or an angled perspective view with respect to the point of interest 502. The user display interface may include user responding device icons 1604 that may be dragged, selected, or otherwise placed within the planning mode interface. The user responding device icons 1604 may indicate a desired location and/or orientation of any actively connected responding devices as determined by the user of the initiating device. For example, placement of a user responding device icon 1604 may provide an indication to the user of the corresponding responding device that the location or orientation of the responding device should be adjusted. Based on the placement of the user responding device icons 1604, location and/or orientation adjustment information transmitted by the initiating device 402 to a responding device may be updated accordingly to reflect a change in desired location and orientation of the responding device with respect to the location of the initiating device 402 and the point of interest 502, as well as the orientation of the initiating device 402.

In some embodiments, the planning mode of the multi-viewpoint image capture application may display a mode selection including various image capture modes such as 3D, panoramic, blur/time lapse, multi-viewpoint/multi-perspective, 360-degree, and 360-degree panoramic.

Location and/or orientation adjustment information may be based at least on a selected image capture mode. For example, FIG. 17 shows a user interface display 520 of a 3D-image planning mode in which a dashed line ring 1702 the case a circumference around which responding device icons 1604 may be positioned. In some embodiments, the initiating device 402 may place the user responding device icons 1604 automatically around the ring 1702 at a distance equivalent to the distance between the initiating device 402 and the point of interest 502. In some embodiments, the user of the initiating device 402 may manually select or place the desired location and orientation of the user responding device icons 1604. For example, the user may “drag and drop” the user responding device icons 1604 to “snap” to the shape of the ring 1702. As another example, the user may override any planning mode to place the user responding device icons 1604 in any desired location or orientation with respect to the user icon 1602 within the user display interface 602. In some embodiments, the size of the ring 1702 may be adjusted based on the physical position of the initiating device 402 with respect to the point of interest 502. For example, the ring 1702 may shrink if the user operating the initiating device 402 moves physically closer to the point of interest 502.

As another example of operating modes, FIG. 18 shows a user interface display 520 of a 3D-image planning mode that may result in a 3D-zooming image capture (e.g., a “gif” gradually zooming inward or outward while appearing to rotate about the point of interest 502). The placement icon 1802 may be customizable by the user of the initiating device 402 to create any conceivable icon shape or size to which the user icon 1602 and the user responding device icons 1604 may be assigned.

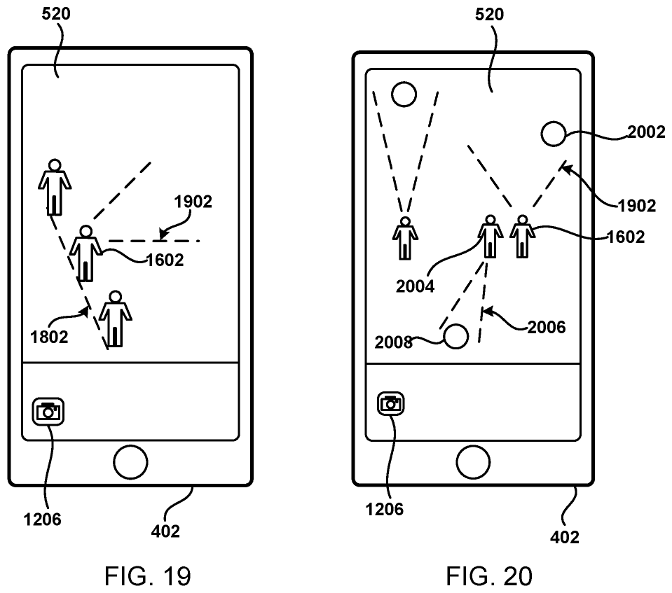

As a further example, the planning mode may display and/or allow the user of the initiating device 402 to select, via the user icon 1602 and user responding device icons 1604 rendered on the graphical user interface, a desired orientation of the initiating device 402 and any active responding devices. For example, as illustrated in FIG. 19, the user display interface 520 may indicate a current camera view angle 1902. The user of the initiating device 402 may adjust the camera view angle 1902 with respect to the placement icon 1802. This may allow the initiating device 402 to be configured to display an indication to the user to adjust the location and/or orientation parameters of the initiating device 402. For example, the user of the initiating device 402 may want to align the respective camera angles of the initiating device 402 and any active responding devices to be perpendicular to the placement icon 1802, such as when performing panoramic image capture.

In some embodiments, the planning mode may allow the user of the initiating device 402 to select varying points of interest and/or camera view angles for the initiating device 402 and any active responding devices. This may be useful for capturing synchronous multi-viewpoint images or image files using multiple camera angles focused on different points of interest. For example, as illustrated in FIG. 20, a user interacting with a user interface display 520 of the initiating device 402 to select a placement of the user icon 1602 and a corresponding camera view angle 1902 to focus on a point of interest 2002. The user of the initiating device 402 may further select a placement of the user responding device icon 2004 and a corresponding camera view angle 2006 to focus on a point of interest 2008. Thus, once image capture begins as initiated by the user of the initiating device 402, images captured synchronously by both the initiating device 402 and the responding device corresponding to the user responding device icon 2004 may have a same timestamp value that can be used to collate or correlate images with varying camera view angles and points of interest.

In some embodiments, the planning mode may display both current locations and orientations of initiating devices and responding devices, as well as desired or user-selected locations and orientations.

In some examples, the initiating device 402 may implement augmented reality (AR) within an environment having a point of interest and one or more active responding devices. For example, a real-time image feed as captured by a camera of the initiating device 402 may include an AR overlay to indicate current locations and orientations of active responding devices, desired locations and orientations of user responding device icons, and locations of points of interest. Similarly, active responding devices may utilize AR to display and allow a user to view current locations and orientations of other active responding devices and the initiating device, desired locations and orientations of other user responding device icons, locations of points of interest.

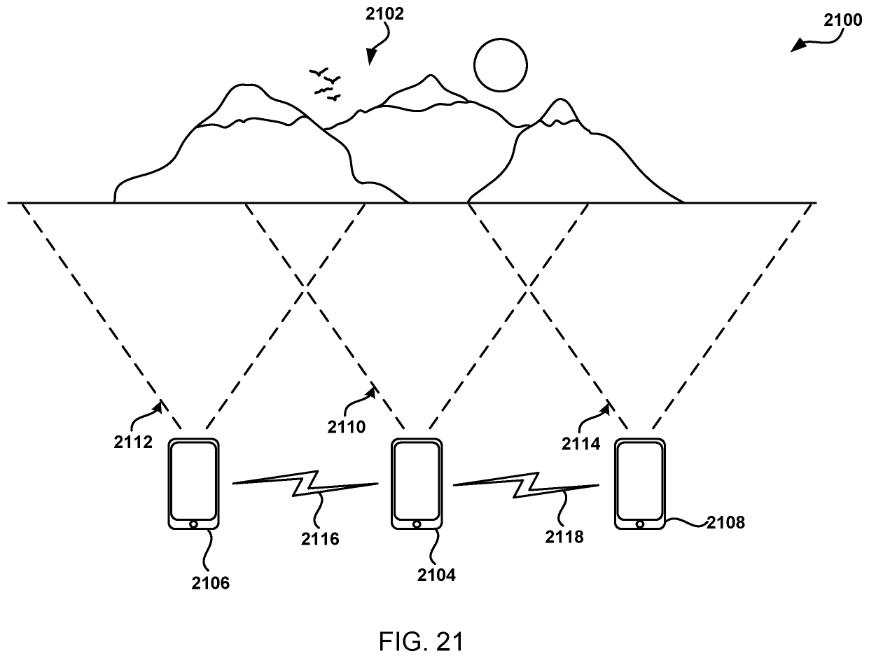

FIG. 21 illustrates an implementation 2100 using various embodiments to capture a panoramic view using an initiating device 2104 and responding devices 2106 and 2108 that have camera view angles 2110, 2112, and 2114, respectively. With reference to FIGS. 1-21, the initiating device 2104 may be in device-to-device communication with the wireless device 2106 via a wireless connection 2116, and with the wireless device 2108 via a wireless connection 2118.

Using various embodiments to perform synchronous panoramic multi-viewpoint photography may be useful to photograph environments in which objects or terrain within the within the panorama are moving (e.g., birds, water surfaces, trees, etc.). For example, a single image capture device may not be able to achieve a single time-synced panoramic image, since a conventional device is unable to simultaneously capture more than one image at any given time. Thus, any changes within the camera viewing angle that occur due to time that passes while performing image capture may result in image distortion. Various embodiments, enable multiple wireless devices to capture a single synchronized panoramic image or video file that eliminates such distortions by collating time-synced images captured at approximately the same time.

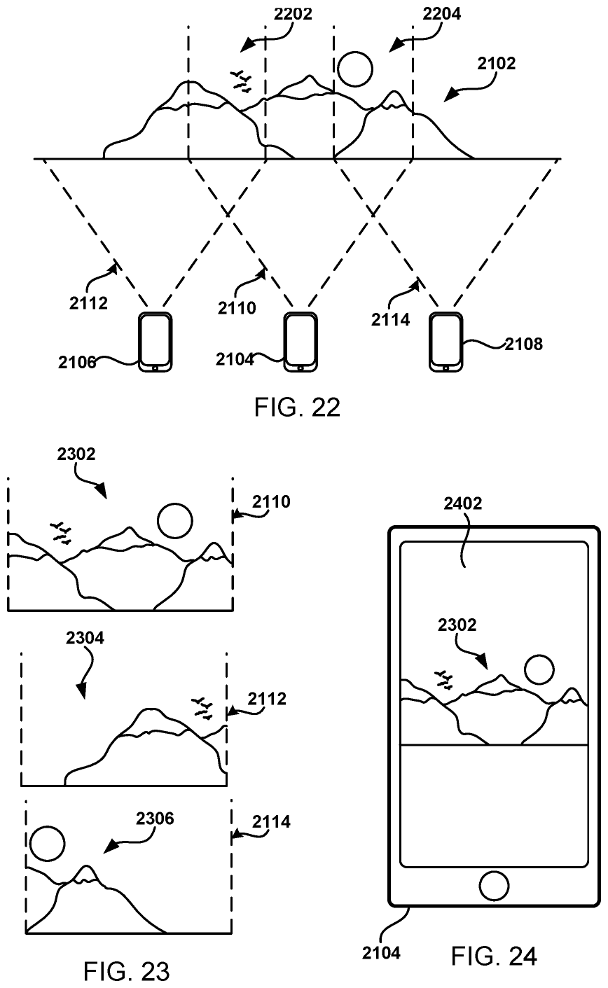

FIG. 22 illustrates an example of positioning multiple wireless devices to perform synchronous panoramic multi-viewpoint photography according to some embodiments. With reference to FIGS. 1-22, the initiating device 2104 and responding devices 2106 and 2108 may be oriented towards a subject of interest 2102. The camera view angles 2110, 2112, and 2114 of the initiating device 2104 and responding devices 2106 and 2108 may be oriented so as to capture overlapping images of a panoramic view. For example, the camera view angles 2110 and 2112 (as displayed within a user display interface of the responding device 2106 and initiating device 2104) include overlapping portion 2202, and the camera view angles 2110 and 2114 may include overlapping portion 2204.

As described, responding devices may transmit preview images to the initiating device that can be processed to determine appropriate adjustment information. Overlapping portions 2202 and 2204 the preview images may be used by the initiating device 2104 to determine how the different device images are aligned and determine appropriate location and/or orientation adjustment information for each of the responding devices 2106 and 2108. In configurations in which the camera view angles of responding devices do not initially include any overlapping portions with a camera view angle of an initiating device, the initiating device may transmit location and/or orientation adjustment information to the responding devices to configure the responding devices to display a notification to the responding device user(s) to adjust the orientation of the responding device(s) (e.g., display message or notification “turn around, “turn right,” etc.). This may be performed until at least a portion of the subject of interest 2102 visible within the camera view angle 2110 is identifiable within the camera view angles 2112 and/or 2114 as determined by the initiating device 2104.

The location and/or orientation adjustment information used in panoramic image capture may be based at least on image processing of the camera view angles 2112 and 2114 with respect to the overlapping portions 2202 and 2204, such that an edge of the camera view angles 2112 and 2114 is at least identifiable within the camera view angle 2110 of the initiating device 2104. For example, FIG. 23 illustrates initiating device 2104 and responding devices 2106 and 2108 camera view angles 2110, 2112, and 2114 that include real-time preview image feed content 2302, 2304, and 2306 respectively. The initiating device 402 may initiate image capture at least when the real-time image feed content 2304 and 2306 overlaps with a portion (e.g., overlapping portions 2202, 2204) of the real-time image feed content 2302. FIG. 24 illustrates an initiating device 2104 displaying a real-time preview image feed 2302 on a user display interface 2402. The location, orientation, and camera settings of the initiating device 2104 may determine the resulting real-time image feed content 2302. The location and/or orientation adjustment information transmitted to the responding devices 2106 and 2108 may be based on the real-time image feed content 2302.

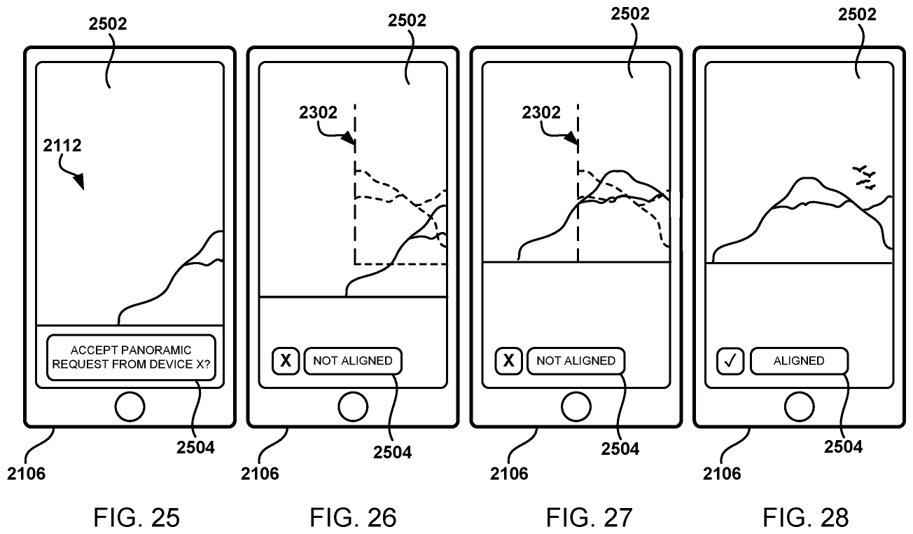

FIGS. 25-28 illustrate a progression of adjusting location and/or orientation parameters of a responding device 2106 while performing synchronous panoramic multi-viewpoint photography according to some embodiments. With reference to FIGS. 1-28, the responding device 2106 may include a user display interface 2502 that displays real-time preview images of the camera view angle 2112. The user display interface 2502 may display an indicator 2504 to provide a notification to the user to accept a request from the initiating device 2104 to perform synchronous panoramic image capture.

As illustrated in FIGS. 26 and 27, after a user accepts the request from the initiating device 2104 to perform synchronous panoramic image capture, the user display interface may display an edge or portion of the real-time preview image feed 2302 transmitted to the responding device 2106. The edge or portion of the real-time image feed content 2302 may be overlaid (e.g., dimmed, outlined, faded, etc.) on top of the real-time image feed content displayed by the user display interface 2502. The real-time image feed content 2302 may be included as location and/or orientation adjustment information or may otherwise be transmitted to the responding device 2106 within the same communication as the location and/or orientation adjustment information. The location and/or orientation adjustment information may include a notification via indicator 2504 to inform the user of the responding device 2106 to adjust a location, orientation, or setting of the responding device 2106. For example, the location and/or orientation adjustment information may include an instruction to configure the indicator 2504 to display a message such as “tilt camera upwards,” an arrow indicator, or any other conceivable user-implementable direction to adjust the orientation of the responding device 2106.

FIG. 28 illustrates the user interface display when the orientation of the responding device 2106 have successfully been adjusted to conform to the location and/or orientation adjustment information received from the initiating device 2104. Thus, the real-time image feed content of the camera view angle 2112 is aligned with a portion of the real-time image feed content 2302. Once aligned, the indicator 2504 may display a notification indicating that the responding device 2106 is properly aligned (i.e. the location and/or orientation parameters of the responding device 2106 correspond to the location and/or orientation adjustment information).

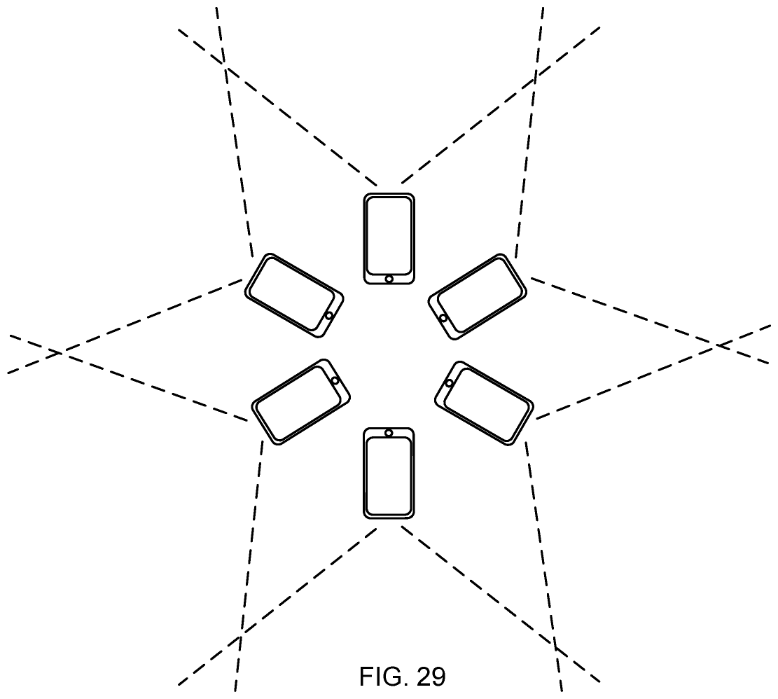

FIG. 29 illustrates an example of using various embodiments for performing 360-degree synchronous panoramic multi-viewpoint photography. Implementing the same concepts as described with reference to FIGS. 21-28, using three or more wireless devices may allow for fully-encompassing 360-degree panoramic image or video capture. For example, multiple devices may be used to synchronously capture images to collate and render a 360-degree panoramic image. Such 360-degree panoramic images may be created in embodiments in which the edges of the camera fields of view of the wireless devices overlap to form a full 360-degree view in a single moment.

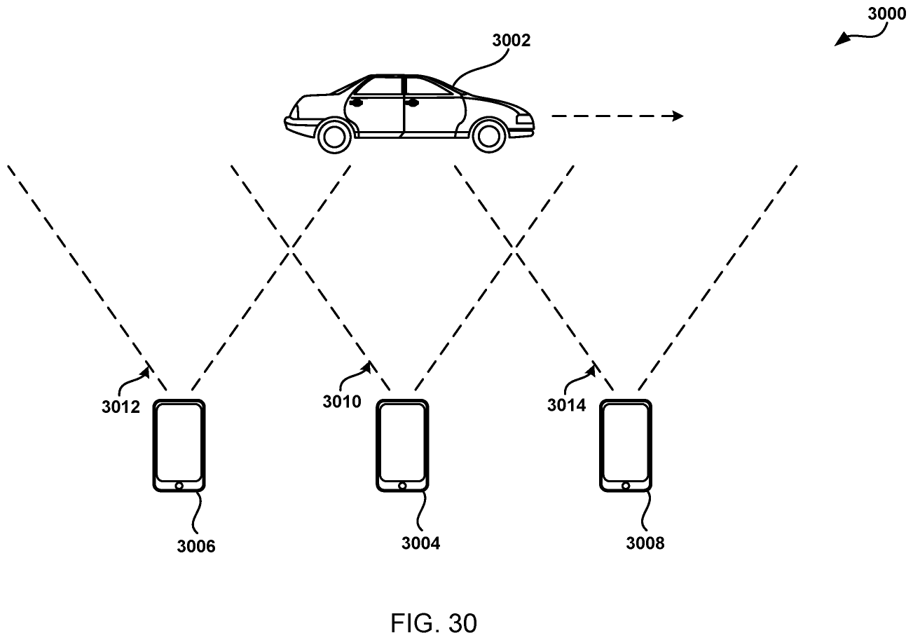

FIG. 30 illustrates an example of using various embodiments for performing synchronous multi-viewpoint photography having a blur effect. For example, an initiating device 3004 may be in wireless communication with responding devices 3006 and 3008, with camera view angles 3010, 3012, and 3014 respectively. The initiating device 3004 may receive a selection from a user to perform synchronous panoramic multi-viewpoint photography using a blur effect. For example, the subject of interest 3002 may be travelling at high speeds, and a user may desire to render an image of the subject of interest 3002 using multiple devices to create a visual blur or time lapse effect. In some embodiments, the location and/or orientation adjustment information transmitted to the responding devices may include an adjustment to a camera exposure setting.

A blur or time lapse effect may be created by offsetting the image capture time of the initiating device 3004 and the responding devices 3006 and 3008. The offset times may be based at least on an order in which the subject of interest 3002 may travel through the collective field of view (e.g., collective view of camera view angles 3010, 3012, and 3014) of the initiating device 3004 and the responding devices 3006 and 3008. For example, as illustrated in FIG. 30, the subject of interest is travelling through the camera view angles 3012, 3010, and 3014 in that order. Thus, to create a blur or time lapse effect from the motion of the subject of interest 3002, the responding device 3006 may capture a first image, the initiating device 3004 may capture a second image sometime after the first image, and the responding device 3008 may capture a third image sometime after the second image. Each image may be stored in a cyclic buffer in each respective device and associated with a timestamp value that is offset by the respective offset time determined by the initiating device 3004. The offset times for each device may be based at least on a velocity of the subject of interest and the desired magnitude of the blur effect. The offset times may be included in the instruction (e.g., communication 452 with reference to FIG. 4) transmitted by the initiating device 3004 to configure the responding devices 3006 and 3008 to begin image capture

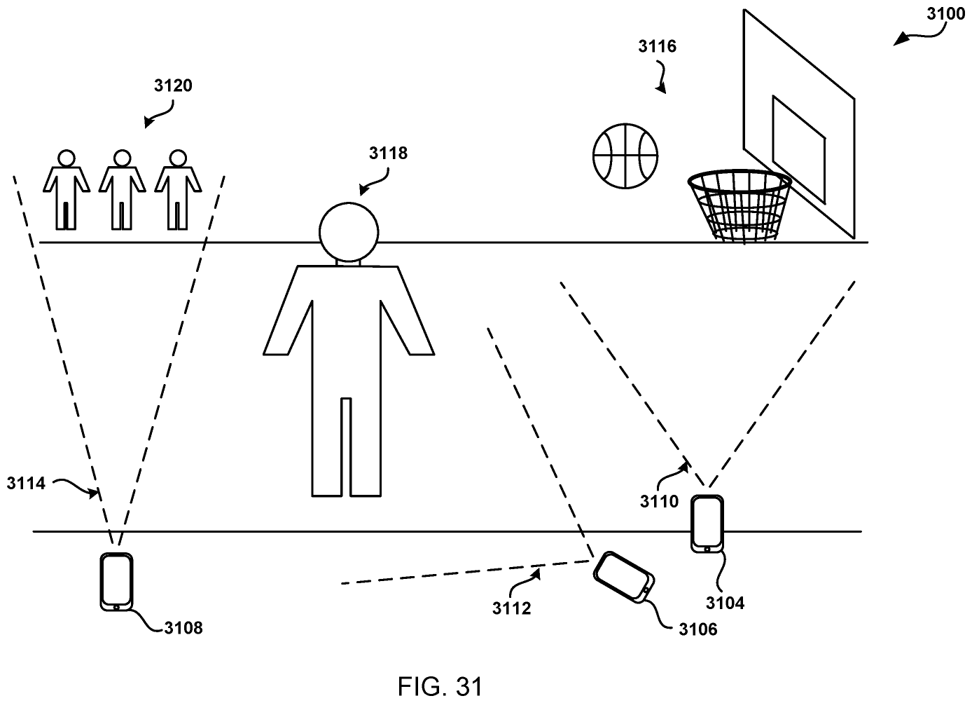

FIG. 31 illustrates an example of using various embodiments for performing synchronous multi-viewpoint photography that show can show the simultaneous actions of various scenes or actors that are not together. For example, synchronous multi-viewpoint photography may be implemented to capture the events or objects present within one camera view angle at the same time as the events or objects in another camera view angle are captured. An initiating device 3104 may be wirelessly connected to responding devices 3106 and 3108. The initiating device 3104 may have a camera view angle 3110 in preparation of capturing a subject of interest 3116. The responding device 3106 may have a camera view angle 3112 in preparation of capturing a subject of interest 3118. The responding device 3108 may have a camera view angle 3114 in preparation of capturing a subject of interest 3120.

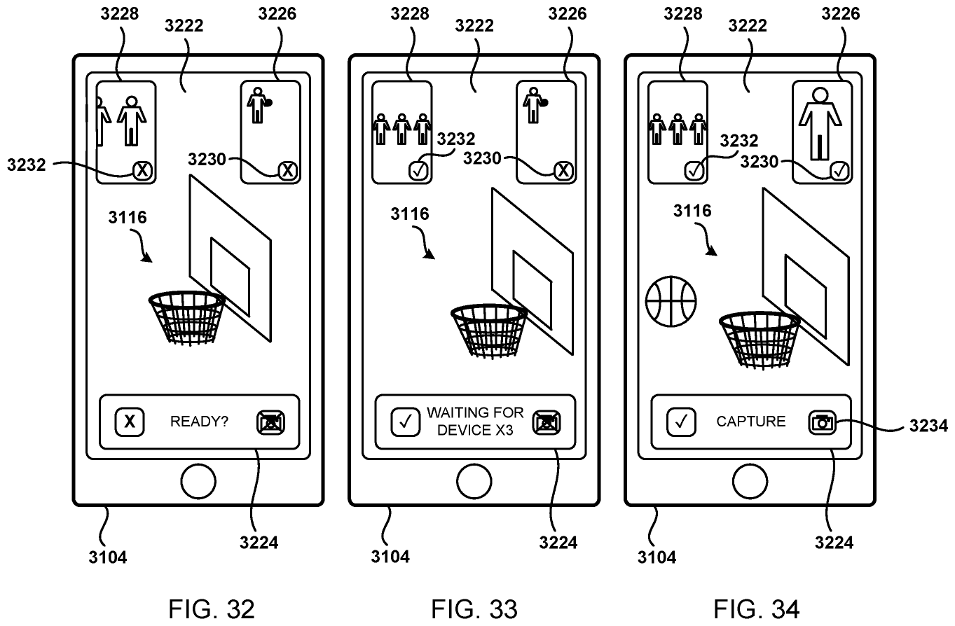

FIGS. 32-34 illustrate an initiating device 3104 showing a user display interface 3222 configured to display a real-time preview image feed including subject of interest 3116 as captured within the camera view angle 3110. The user display interface 3222 may be configured to display a real-time preview image feed 3226 including subject of interest as captured within the responding device camera view angle 3112. The user display interface 3222 may be configured to display a real-time preview image feed 3228 including subject of interest as captured within the responding device camera view angle 3114. The initiating device 3104 may continuously receive real-time preview image feeds from the responding devices 3106 and 3108 to enable monitoring the fields of view of all responding devices.

The user display interface 3222 may be configured to display a status indicator 3224 indicating whether the initiating device 3104 is ready to begin image capture. In some embodiments, the initiating device 3104 may receive a selection from the user, such as a manual selection of the status indicator 3224, to alternate the status between “not ready” and “ready.” For example, as illustrated in FIG. 33, the status indicator 3224 may display an indication (e.g., check mark) to indicate to the user of the initiating device 3104 that the initiating device 3104 is ready to begin image capture. In some embodiments, the initiating device 3104 may automatically determine a transition between a “not ready” and “ready” status. For example, the initiating device 3104 may automatically determine a “ready” status by processing images captured in real time within the camera view angle 3110 to determine that the camera is focused on the subject of interest 3116. As another example, the initiating device may automatically determine a “ready” status by determining, via accelerometers, that the initiating device 3104 has not been moved or otherwise reoriented for a period of time. In some embodiments, the initiating device 3104 may transmit an instruction to configure the responding devices 3106 and 3108 to display, in their respective user display interfaces, an indication or notification that the initiating device 3104 is ready to begin image capture.

The responding devices 3106 and 3108 may determine a transition between a “not ready” and a “ready” status manually or automatically in a manner similar to the initiating device 3104. In some embodiments, the responding devices 3106 and 3108 may separately transmit instructions to the initiating device 3104 to configure the initiating device 3104 to display, via indicators 3230 and 3232 respectively, an indication or notification that the responding devices 3106 and 3108 are ready to begin image capture. For example, as illustrated in FIG. 34, the indicators 3230 and 3232 may display an indication (e.g., check mark) that the responding devices 3106 and 3108 are ready to begin image capture.

As illustrated in FIG. 34, once all devices indicate a “ready” status, the indicator 3224 may indicate or otherwise display a notification alerting the user that all devices are ready to begin image capture. For example, an image capture initialization icon 3234 may be unlocked, highlighted, or otherwise available for the user of the initiating device 3104 to select to begin image capture across the initiating device 3104 and responding devices 3106 and 3108. In some embodiments, the initiating device 3104 may receive a selection to begin image capture despite any responding device being in a “not ready” state.

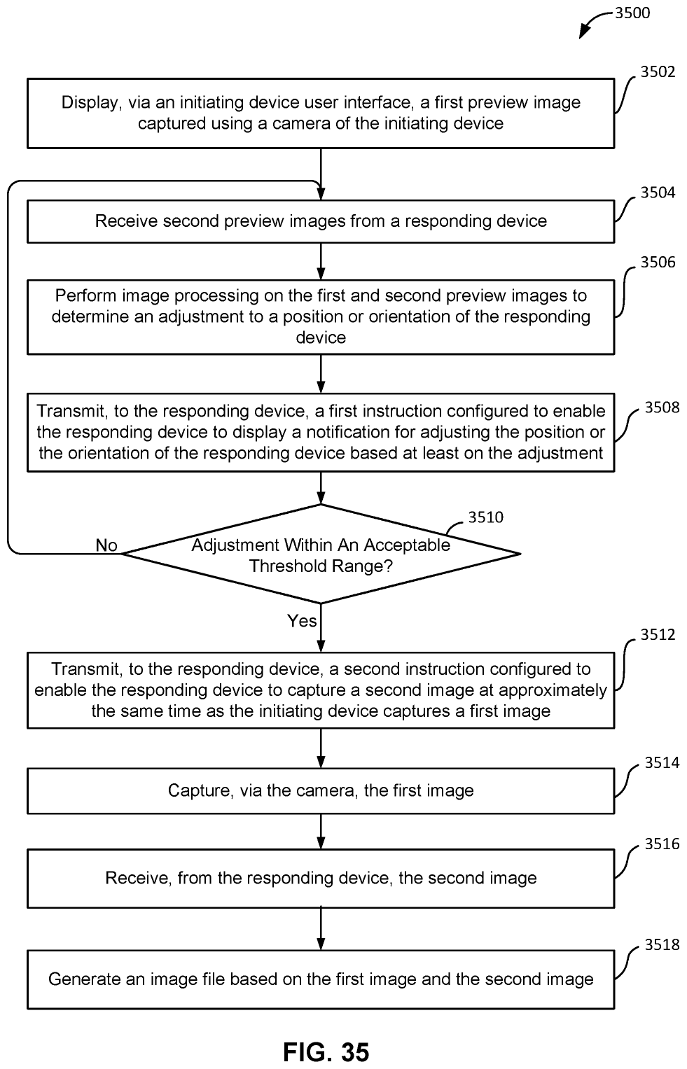

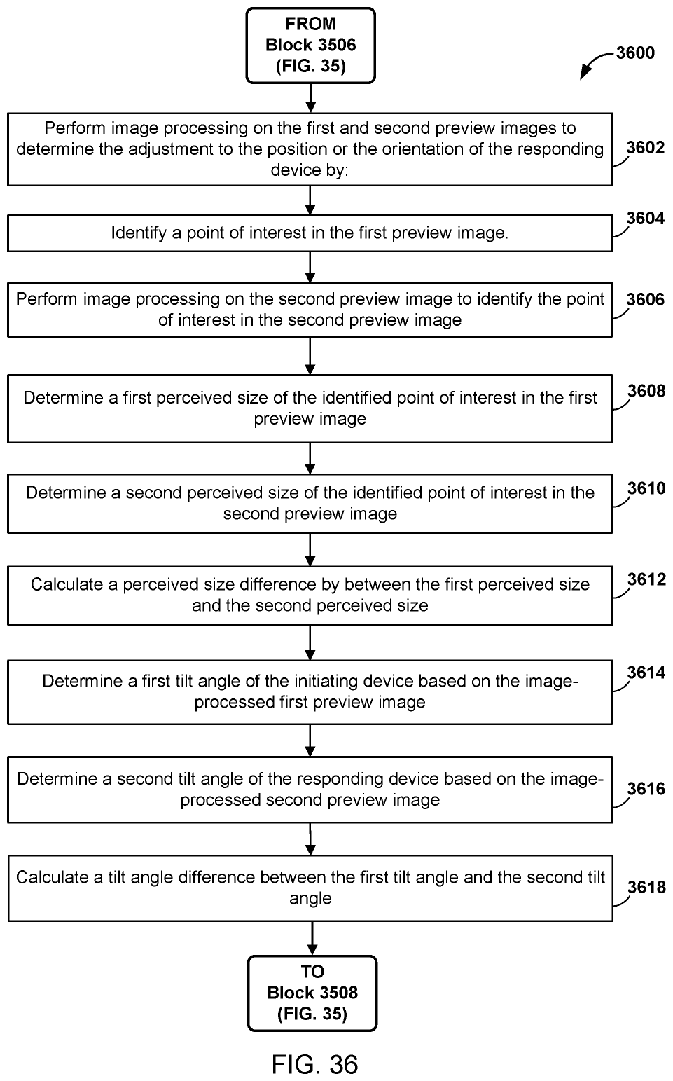

FIG. 35 is a process flow diagram illustrating a method 3500 implementing an initiating device to perform synchronous multi-viewpoint photography according to some embodiments. With reference to FIGS. 1-35, the operations of the method 3500 may be performed by a processor (e.g., processor 210, 212, 214, 216, 218, 252, 260, 322) of a wireless device (e.g., the wireless device 120a-120e, 200, 320, 402, 404).

The order of operations performed in blocks 3502-3518 is merely illustrative, and the operations of blocks 3502-3518 may be performed in any order and partially simultaneously in some embodiments. In some embodiments, the method 3500 may be performed by a processor of an initiating device independently from, but in conjunction with, a processor of a responding device. For example, the method 3500 may be implemented as a software module executing within a processor of an SoC or in dedicated hardware within an SoC that monitors data and commands from/within the server and is configured to take actions and store data as described. For ease of reference, the various elements performing the operations of the method 3500 are referred to in the following method descriptions as a “processor.”

In block 3502, the processor may perform operations including displaying, via an initiating device user interface, a first preview image captured using a camera of the initiating device. A camera of an initiating device may be used to render a preview image or an image feed on a display of a user interface to allow a user to observe a camera view angle in real time. Displaying the preview image may allow the user to position or orient the wireless device, or adjust camera settings to focus on a subject or a point of interest such that the preview image may contain the subject or point of interest. In some embodiments, the initiating device may transmit the first preview image to one or more responding devices, with the first preview image configured to be displayed within a responding device user interface to guide a user of the responding device to adjust the position or the orientation of the responding device. In some embodiments, the initiating device may display and transmit additional preview images to one or more responding devices after a position, orientation, or camera setting of the initiating device has been adjusted.

In block 3504, the processor may perform operations including receiving second preview images from a responding device. The initiating device may receive one or more preview images from one or more responding devices. The images can be displayed to the user interface of the initiating device and/or processed to determine whether an adjustment to a position, orientation, or camera setting of any responding device is needed for purposes of configuring synchronous multi-viewpoint photography in various modes (e.g., 3D, panoramic, blur or time lapse, multi-viewpoint, 360-degree 3D, and 360-degree panoramic mode). The received preview images may be used by the initiating device to determine (or enable a user to determine) whether an adjustment to a position, orientation, or camera setting of a responding device is needed for purposes of configuring synchronous multi-viewpoint photography. In some embodiments, the received preview image may be used by the initiating device to automatically determine whether an adjustment to a position, orientation, or camera setting of a responding device is needed for purposes of configuring synchronous multi-viewpoint photography.

In some embodiments, receiving a first preview image from an initiating device may include receiving and displaying a first preview image feed captured by the camera of the initiating device. In some embodiments, receiving second preview images from a responding device may include receiving and displaying a second preview image feed captured by a camera of the responding device.

In block 3506, the processor may perform operations including performing image processing on the first and second preview images to determine an adjustment to a position or orientation of the responding device. The initiating device may perform image processing to identify and determine parameters of a feature, subject or point of interest in a preview image. For example, the initiating device may perform image processing on a preview image to determine that a point of interest, identified by a user or automatically identified, is centered within a frame of the camera view angle and consequently the image feed as displayed on the user interface of the initiating device. As another example, the initiating device may perform image processing on a preview image to identify a size, height, width, elevation, shape, distance from camera or depth, and camera and/or device tilt angle in three dimensions. In some embodiments, the image processing may be based on automatic based on depth-sensing, object recognition machine-learning, and eye tracking. By comparing the determined parameters of a common subject or point of interest in a first preview image from an initiating device and a second preview image from a responding device, the initiating device can determine what adjustment to a position, orientation, or camera setting of the responding device is needed based on the implemented photography mode.

In block 3508, the processor may perform operations including transmitting, to the responding device, a first instruction configured to enable the responding device to display a notification for adjusting the position or the orientation of the responding device based at least on the adjustment. Based on the determined adjustment in block 3506, the initiating device may transmit an instruction or notification to the responding device including the adjustment information, which describes how a position, orientation, or camera setting of the responding device should be manually or automatically adjusted. In some embodiments, the instruction can be configured to cause indicators to be displayed on an interface of the responding device to guide a user to adjust the responding device accordingly. In some embodiments, the instruction may be configured to automatically adjust a camera setting (e.g., focus, zoom, flash, etc.) of the responding device.

In block 3510, the processor may perform operations including determining whether the determined adjustment is within an acceptable threshold range for conducting simultaneous multi-viewpoint photography. The initiating device may determine whether the position, orientation, or camera settings of a responding device as determined from image processing performed in block 3506 correspond to the location and/or orientation adjustment information transmitted in communication 436. In other words, the initiating device 402 may determine whether the responding device 404 is “ready” to perform synchronous multi-viewpoint photography, such that the responding device 404 is at a desired, ultimate location and orientation (e.g., elevation, tilt angle, camera settings and features, etc.). The desired location and orientation of a responding device with respect to a point of interest and an initiating device may vary depending on the photography or video capture mode enabled. For example, a 3D image capture mode may indicate to the users of an initiating device and any number of responding devices to be at an equivalent distance from a point of interest and to have a same tilt angle. As another example, a panoramic image capture mode may indicate to the users of an initiating device and any number of responding devices to orient the devices in a linear manner with cameras facing a same direction (e.g., a horizon).

In some embodiments, determining whether the adjustment determined in block 3506 is within an acceptable threshold range of the location and/or orientation adjustment information may include determining that further adjustments to the position, orientation, or camera settings of the responding device are needed (i.e. the determined adjustment in block 3506 is outside of a threshold range), or that no further adjustments to the position, orientation, or camera settings of the responding device are needed (i.e. the determined adjustment is block 3506 is within a threshold range). When the initiating device determines that no further adjustments to the responding device are needed, the responding device may be considered to be in a “ready” state, such that synchronous image capture may begin. For example, the initiating device may determine that a responding device is in a ready state if the camera tilt angle is at least within a threshold range of 5 degrees. As another example, the initiating device may determine that a responding device is in a ready state if within 0.25 meters of a desired location with respect to a point of interest. As a further example, the initiating device may determine that a responding device is in a ready state if a point of interest is centered within preview images. Image processing may be implemented after obtaining a preview image to account for any variance within a tolerable threshold range for the location and/or orientation parameters of any responding device.

In some embodiments, the initiating device may determine that the determined adjustment is not within an acceptable threshold range for conducting simultaneous multi-viewpoint photography. In response to determining that the determined adjustment is not within the acceptable threshold range for conducting simultaneous multi-viewpoint photography, the initiating device may transmit the first instruction configured to enable the responding device to display the notification for adjusting the position or the orientation of the responding device based at least on the adjustment. In response to determining that the determined adjustment is not within an acceptable threshold range for conducting simultaneous multi-viewpoint photography, processes described in blocks 3504 through 3508 may be repeated until no further adjustment to the responding device is needed. In other words, the initiating device may determine that a responding device is not in a “ready” status until the responding device has been positioned and oriented correctly with respect to the initiating device, a subject or point of interest, and/or any other responding devices. This may be performed by continuously receiving preview images from the responding device, processing the preview images to determine whether an adjustment is needed, and transmitting updated adjustment information in an instruction to the responding device. For example, the initiating device may receive further second preview images from the responding device, performing image processing on the first preview image and the further second preview images to determine a second adjustment to the position or the orientation of the responding device, and transmit, to the responding device, a third instruction configured to enable the responding device to display a second notification for adjusting the position or the orientation of the responding device based at least on the second adjustment.

In block 3512, the processor may perform operations including transmitting, to the responding device, a second instruction configured to enable the responding device to capture a second image at approximately the same time as the initiating device captures a first image. The processes described in block 3512 may be performed after the initiating device determines that no further adjustments to the responding device are needed, such that the responding device is in a “ready” status to begin image capture. For example, the initiating device may transmit the second instruction in response to determining that the determined adjustment is within the acceptable threshold range for conducting simultaneous multi-viewpoint photography.

The second instruction may include configuration information to implement one or more various methods for synchronous image capture. In some embodiments, the initiating device may store a first time value when the first image is captured. The second instruction may include this first time value. The second image, or the image captured by the responding device as a result of implementing or otherwise being configured by the second instruction received from the initiating device, may be associated with a second time value corresponding to when the second image is captured. The second time value may be approximate to the first time value. For example, the instruction transmitted by the initiating device may include the time (e.g., timestamp) at which the image was captured by the initiating device, The responding device may use this time value associated with the initiating device captured image to determine which of any images captured in a cyclic buffer of the responding device have timestamps closest to the timestamp of the image captured by the initiating device.

In some embodiments, the instruction may include an initiate time value corresponding to the time that a user-initiated image capture (e.g., as described with reference to operation 450 of FIG. 4). In some embodiments, the initiate time value may be based on the time synchronization values received by the initiating device and the responding device, such as GNSS time signals (e.g., as described with reference to communications 416 and 418 of FIG. 4). The time synchronization values, as stored on the initiating device and the responding device, may be used to identify and correlate images captured and stored within cyclic buffers within each device. In some embodiments, the initiate time value may be based at least on a local clock frequency of the initiating device.

In some embodiments, the instruction transmitted by the initiating device may include configuration information to automatically initiate the generation of an analog signal for purposes of synching image capture. An analog signal may be generated and output by the initiating device to initiate image capture. For example, the initiating device may generate a flash via the camera flash or an audio frequency “chirp” via speakers to instruct the responding device to begin image capture automatically. The responding device may be capable of detecting a flash or audio frequency “chirp” generated by the initiating device, and may begin the process to capture at least one image. In some embodiments, a test analog signal may be generated to determine the time between generation of the analog signal and the time upon which the responding device detects the analog signal. The determined analog latency value may be used to offset when the responding device may begin generating a camera flash for purposes of image capture and/or when the responding device begins image capture.

In some embodiments, the instruction transmitted by the initiating device may include a delay value. The responding device may be configured to display an indication to initiate or otherwise automatically initiate image capture after the duration of the delay value has passed. A delay value may reduce the amount of electronic storage used when capturing more than one image in a cyclic buffer, such that proceeding to capture images after a certain delay value may be closer to the point in time in which the initiating device begins capturing at least one image. The delay value may be based at least on a latency between the initiating device and the responding device (e.g., Bluetooth Low Latency (BLE) communications latency), where the latency is caused by wireless communications protocols and handshaking and physical distance separating the devices. A delay value may include additional delay time in embodiments involving more than one responding device, such that each responding device may have a different latency value for communications with the initiating device. For example, the delay value may be equal to at least the time value of the largest latency value among the involved responding devices. Thus, the automatic capture of images by each responding device may be offset by at least the difference between their individual time delays and the largest latency value among the responding devices.

In some embodiments, the instruction transmitted by the initiating device to begin image capture may include a command to be executed by the responding device, such as to display an indication on the user interface display of the responding device to instruct the user to initiate image capture manually.

In block 3514, the processor may perform operations including capturing, via the camera, the first image. After performing operations as described in block 3512 to initiate image capture, the initiating device may capture one or more images. In some examples, capturing one or more images may be initiated at least after a time delay according to various embodiments.

In block 3516, the processor may perform operations including receiving, from the responding device, the second image. The initiating device may receive one or more images from the responding device associated with an image captured by the initiating device as described in block 3512. The one or more images received from the responding device may have timestamps approximate to the timestamps of any image captured by the initiating device.

In block 3518, the processor may perform operations including generating an image file based on the first image and the second image. Depending on the image capture mode (e.g., 3D, panoramic, blur or time lapse, multi-viewpoint, 360-degree 3D, and 360-degree panoramic mode), the generated image file may have different stylistic and/or perspective effects. In some embodiments in which an initiating device, responding device, and any other responding devices each capture multiple images in a sequence or burst fashion, the plurality of images may be used to generate a time-lapse image file, or a video file. In some examples, the first image, the second image, and any additional images taken by the initiating device, the responding device, and any other responding devices may be uploaded to a server for image processing and generation of the image file. This may save battery life and resources for the initiating device.

FIG. 36 is a process flow diagram illustrating alternative operations 3600 that may be performed by a processor (e.g., processor 210, 212, 214, 216, 218, 252, 260, 322) of a wireless device (e.g., the wireless device 120a-120e, 200, 320, 402, 404) as part of the method 3500 for performing synchronous multi-viewpoint photography according to some embodiments.

Referring to FIG. 36, in some embodiments following the performance of block 3506 of the method 3500 (FIG. 35), the processor may perform operations described in blocks 3604 through 3618. For example, in block 3602, the processor may perform operations including performing image processing on the first and second preview images to determine the adjustment to the position or the orientation of the responding device by performing the operations as described with respect to blocks 3604 through 3618.

In block 3604, the processor may perform operations including identifying a point of interest in the first preview image. In some embodiments, identifying the point of interest in the first preview image may include receiving a user input on the user interface identifying a region or feature appearing in the first preview image. In some embodiments, identifying the point of interest in the first preview image may include performing image processing to identify as the point of interest a prominent feature centered in the first preview image.

In block 3606, the processor may perform operations including performing image processing on the second preview image to identify the point of interest in the second preview image. Identifying the point of interest in the second preview image may be performed similarly to identifying the point of interest in the first preview image as described in block 3604.

In block 3608, the processor may perform operations including determining a first perceived size of the identified point of interest in the first preview image. For example, the initiating device may perform image processing to determine the size of an object with respect to height and width dimensions at a depth from the camera of the initiating device.

In block 3610, the processor may perform operations including determining a second perceived size of the identified point of interest in the second preview image. For example, the initiating device may perform image processing to determine the size of an object with respect to height and width dimensions at a depth from the camera of the responding device.

In block 3612, the processor may perform operations including calculating a perceived size difference between the first perceived size and the second perceived size. The calculated perceived size difference may be used to determine or may be otherwise included in adjustment information for adjusting a position, orientation, or camera setting of the responding device. For example, the adjustment transmitted to the responding device as part of the instruction as described in block 3508 of the method 3500 (FIG. 35) may be based at least on the perceived size difference.

In block 3614, the processor may perform operations including determining a first tilt angle of the initiating device based on the first preview image such as after image processing. A tilt angle may include any degree of rotation or orientation with respect to 3D space. In some embodiments, the tilt angle may be referenced with respect to a global tilt angle based on gravitational forces (e.g., accelerometers) or with respect to a reference point, such as a subject or point of interest as identified within a preview image.

In block 3616, the processor may perform operations including determining a second tilt angle of the responding device based on the second preview image such as after image processing.

In block 3618, the processor may perform operations including calculating a tilt angle difference between the first tilt angle and the second tilt angle. The calculated tilt angle difference may be used to determine or may be otherwise included in adjustment information for adjusting a position, orientation, or camera setting of the responding device. For example, the adjustment transmitted to the responding device as part of the instruction as described in block 3508 of the method 3500 (FIG. 35) may be based at least on the tilt angle difference.

The processor may then perform the operations of block 3508 of the method 3500 (FIG. 35) as described.

In some embodiments, the initiating device may receive a third preview image from a second responding device, perform image processing on the third preview image to determine a second adjustment to a second position or a second orientation of the second responding device, and transmit, to the second responding device, a third instruction configured to enable the second responding device to display a second notification based at least on the second adjustment.

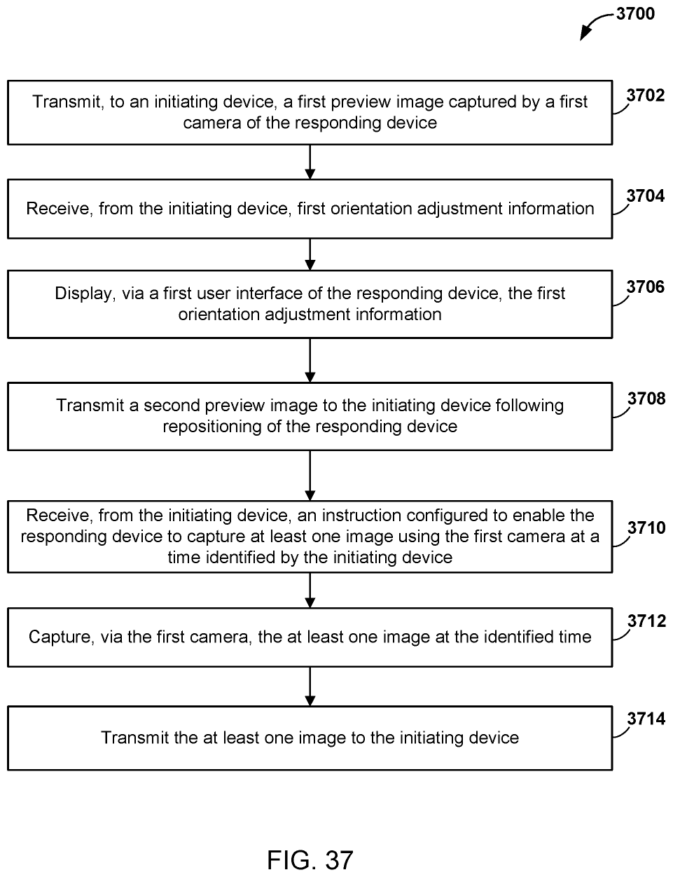

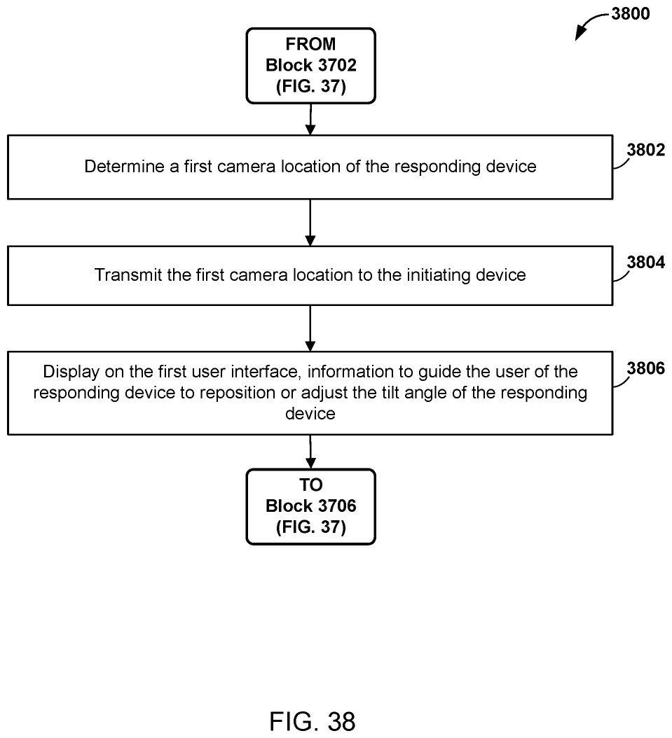

FIG. 37 is a process flow diagram illustrating a method 3700 implementing a responding device to perform synchronous multi-viewpoint photography according to various embodiments. With reference to FIGS. 1-37, the operations of the method 3700 may be performed by a processor (e.g., processor 210, 212, 214, 216, 218, 252, 260, 322) of a wireless device (e.g., the wireless device 120a-120e, 200, 320, 402, 404).

The order of operations performed in blocks 3702-3714 is merely illustrative, and the operations of blocks 3702-3714 may be performed in any order and partially simultaneously in some embodiments. In some embodiments, the method 3700 may be performed by a processor of an initiating device independently from, but in conjunction with, a processor of a responding device. For example, the method 3700 may be implemented as a software module executing within a processor of an SoC or in dedicated hardware within an SoC that monitors data and commands from/within the server and is configured to take actions and store data as described. For ease of reference, the various elements performing the operations of the method 3700 are referred to in the following method descriptions as a “processor.”

In block 3702, the processor may perform operations including transmitting, to an initiating device, a first preview image captured by a first camera of the responding device. The responding device may transmit one or more preview images to the initiating device, where the preview images can be displayed to the user interface of the initiating device and/or processed to determine whether an adjustment to a position, orientation, or camera setting of the responding device is needed for purposes of configuring synchronous multi-viewpoint photography in various modes (e.g., 3D, panoramic, blur or time lapse, multi-viewpoint, 360-degree 3D, and 360-degree panoramic mode). The transmitted preview image may be used by the initiating device to allow a user to determine whether an adjustment to a position, orientation, or camera setting of a responding device is needed for purposes of configuring synchronous multi-viewpoint photography. In some embodiments, the transmitted preview image may be used by the initiating device to automatically determine whether an adjustment to a position, orientation, or camera setting of a responding device is needed for purposes of configuring synchronous multi-viewpoint photography. In some embodiments, transmitting a first preview image from a responding device may include receiving and displaying a first preview image feed captured by the camera of the responding device.

In block 3704, the processor may perform operations including receiving, from the initiating device, first location and/or orientation adjustment information. The first location and/or orientation adjustment information may be included as part of a notification or instruction configured to enable the responding device to display the location and/or orientation adjustment information.

In block 3706, the processor may perform operations including displaying, via a first user interface of the responding device, the first location and/or orientation adjustment information. The location and/or orientation adjustment information can be used by the responding device or can guide a user of the responding device to adjust a position, orientation, or camera setting of the responding device. In some embodiments, the instruction may be configured to cause indicators, such as messages or arrows, to be displayed on a user interface of the responding device to guide a user to adjust the responding device accordingly. In some embodiments, the instruction may be configured to automatically adjust a camera setting (e.g., focus, zoom, flash, etc.) of the responding device.

In some embodiments, the responding device may receive an indication of a point of interest for imaging from the initiating device, and may display, via the user interface of the responding device, the first preview image and the indication of the point of interest within the first preview image. In some embodiments, the responding device may receive, from the initiating device, an image including a point of interest, and display the image within the first user interface with an indication of the point of interest. Displaying a reference or preview image received from the initiating device may allow a user of the responding device to reference the preview image for purposes of adjusting a position, orientation, or camera setting of the responding device. The visual representation can allow a user of the responding device to compare the image or image feed received from the initiating device with a current image or image feed as captured by the camera of the responding device and rendered within a user interface of the responding device.

In block 3708, the processor may perform operations including transmitting a second preview image to the initiating device following repositioning of the responding device. After the position, orientation, or camera settings of the responding device have been adjusted accordingly based at least on the location and/or orientation adjustment information received and displayed as described in blocks 3704 and 3706, the responding device may transmit another preview image to the initiating device. The initiating device may use the second preview image to determine whether any additional location and/or orientation adjustment information is needed by the responding device to correctly adjust the position, orientation, or camera settings of the responding device. For example, if a responding device is adjusted, but varies too much from the location and/or orientation adjustment information, the responding device may transmit the latest preview image, and the initiating device may determine that the responding device is outside the threshold of the location and/or orientation adjustment information originally received by the responding device as described in block 3704, and therefore indicating that the responding device is not ready to begin image capture. Thus, the processes described in block 3702 through 3708 may be repeated until the responded device is positioned, oriented, or otherwise configured correctly according to the last received location and/or orientation adjustment information.

In block 3710, the processor may perform operations including receiving, from the initiating device, an instruction configured to enable the responding device to capture at least one image using the first camera at a time identified by the initiating device. The processes described in block 3710 may be performed after the initiating device determines that no further adjustments to the responding device are needed, such that the responding device is in a “ready” status to begin image capture. For example, the responding device may receive the instruction in response to the initiating device determining that the position, orientation, and/or camera settings of the responding device, as determined from the second preview image, are within an acceptable threshold range defined by the received location and/or orientation adjustment information.

The instruction may include configuration information to implement one or more various methods for synchronous image capture. In some embodiments, the responding device, as part of the instruction, may receive a time value for when the initiating device captures an image. In some embodiments, the time value may be received by the responding device as part of a separate instruction after receiving the initial instruction configured to enable the responding device to capture at least one image.

The image captured by the responding device as a result of implementing or otherwise being configured by the instruction received from the initiating device may be associated with one or more time values corresponding to when the responding device captures one or more images. The time values associated with any images captured by the responding device may be approximate to the time identified by the initiating device. For example, the instruction received by the responding device may include the time (e.g., timestamp) at which the image was captured by the initiating device. The responding device may use this identified time value associated with the initiating device captured image to determine which of any images captured in a cyclic buffer of the responding device have timestamps closest to the timestamp of the image captured by the initiating device.

In block 3712, the processor may perform operations including capturing, via the first camera, the at least one image at the identified time. After performing operations as described in block 3710 to initiate image capture, the responding device may capture one or more images. In some examples, capturing one or more images may be initiated at least after a time delay according to various embodiments. If multiple images are captures in a series or burst fashion, the images may be stored within a cyclic buffer that may be referenced by timestamps corresponding to the time at which the images were captured by the camera of the responding device.

In block 3714, the processor may perform operations including transmitting the at least one image to the initiating device. The responding device may transmit one or more images from the responding device associated with an image captured by the initiating device. The one or more images transmitted by the responding device may have timestamps approximate to the timestamps of any image captured by the initiating device that is received as described in block 3710.

FIG. 38 is a process flow diagram illustrating alternative operations 3800 that may be performed by a processor (e.g., processor 210, 212, 214, 216, 218, 252, 260, 322) of a wireless device (e.g., the wireless device 120a-120e, 200, 320, 402, 404) as part of the method 3700 for performing synchronous multi-viewpoint photography according to some embodiments.

Following the performance of the operations of block 3702 of the method 3700, the processor may perform operations including determining a first camera location of the responding device in block 3802. A first camera location of the responding device may be determined by GNSS or other geolocation methods. In some embodiments, a first camera location may be based on processing a preview image displayed within a user interface of the responding device.

In block 3804, the processor may perform operations including transmitting the first camera location to the initiating device. Receiving first location and/or orientation adjustment information from the initiating device may include information configured to be displayed on the first user interface to guide a user of the responding device to move the first camera to a second location removed from the first camera location or to adjust a tilt angle of the first camera.

In block 3806, the processor may perform operations including displaying on the first user interface, information to guide the user of the responding device to reposition or adjust the tilt angle of the responding device.

The processor may then perform the operations of block 3706 of the method 3700 (FIG. 37) as described.

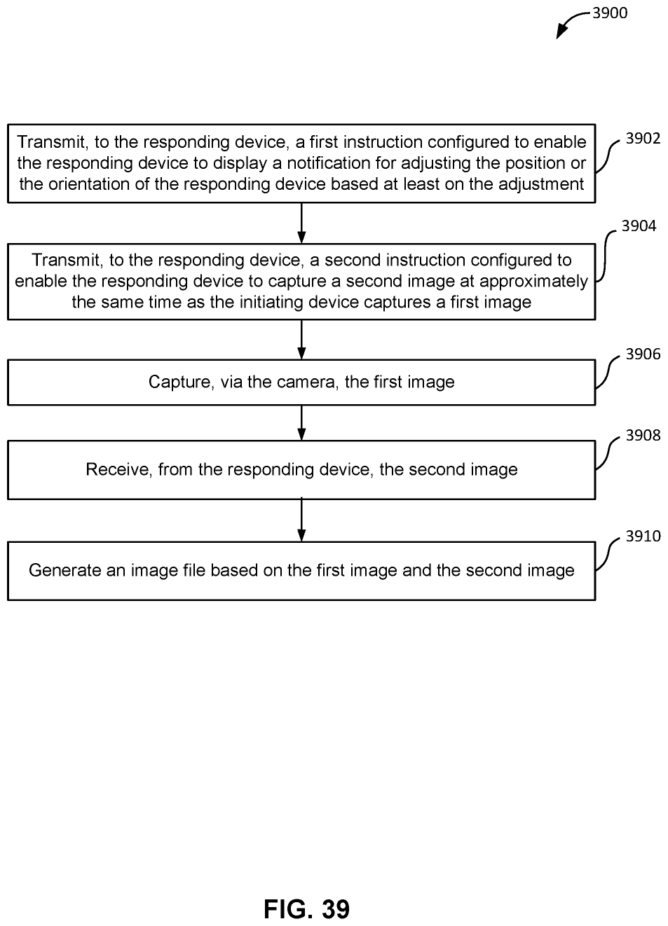

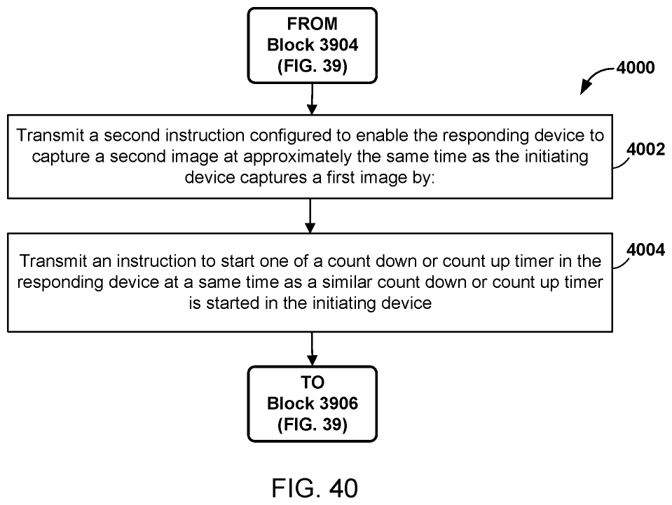

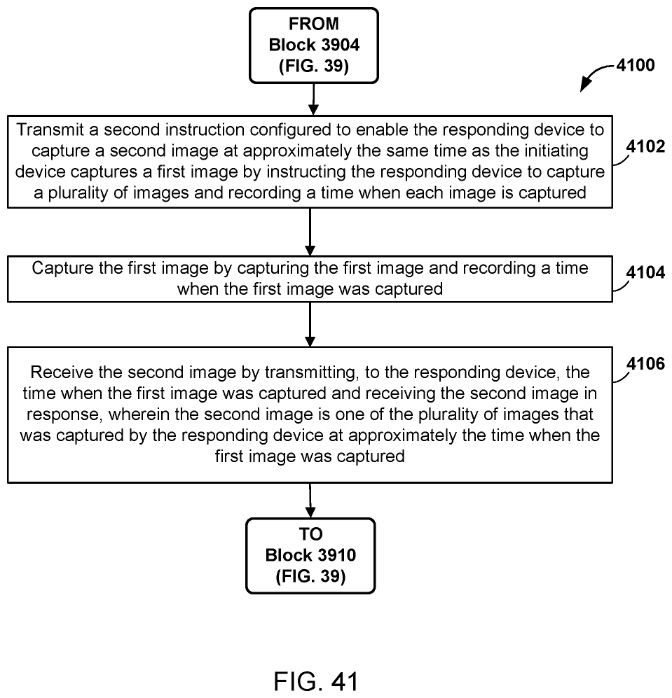

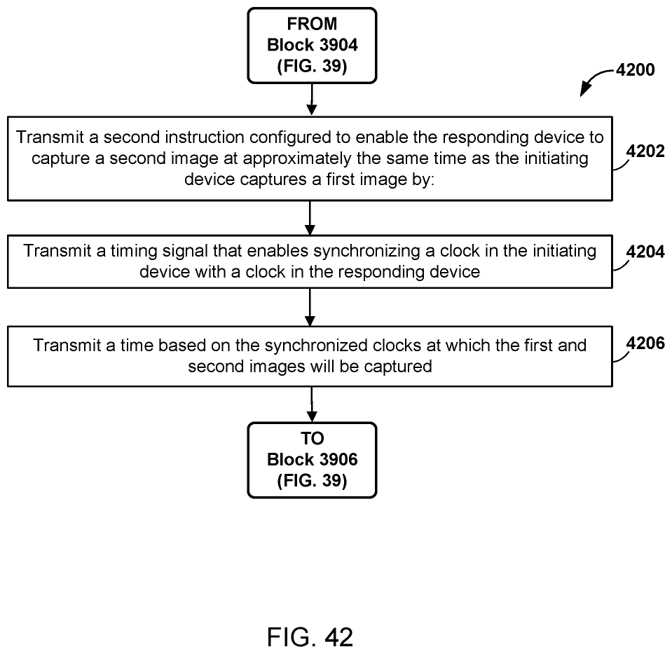

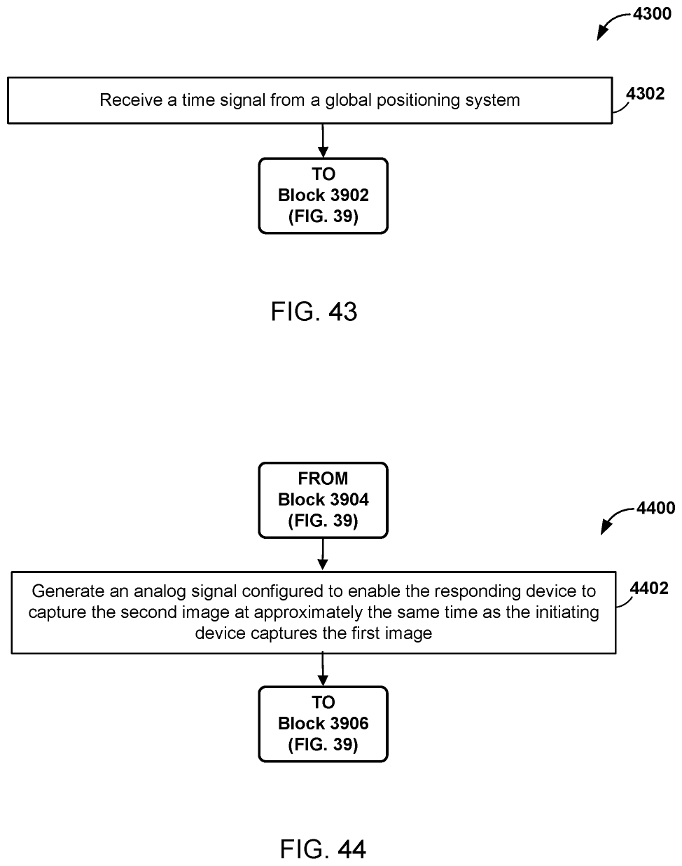

FIG. 39 is a process flow diagram illustrating a method 3900 implementing an initiating device to perform synchronous multi-viewpoint photography according to various embodiments. With reference to FIGS. 1-39, the operations of the method 3900 may be performed by a processor (e.g., processor 210, 212, 214, 216, 218, 252, 260, 322) of a wireless device (e.g., the wireless device 120a-120e, 200, 320, 402, 404).

The order of operations performed in blocks 3902-3910 is merely illustrative, and the operations of blocks 3902-3910 may be performed in any order and partially simultaneously in some embodiments. In some embodiments, the method 3900 may be performed by a processor of an initiating device independently from, but in conjunction with, a processor of a responding device. For example, the method 3900 may be implemented as a software module executing within a processor of an SoC or in dedicated hardware within an SoC that monitors data and commands from/within the server and is configured to take actions and store data as described. For ease of reference, the various elements performing the operations of the method 3900 are referred to in the following method descriptions as a “processor.”

In block 3902, the processor may perform operations including transmitting, to a responding device, a first instruction configured to enable the responding device to display a notification for adjusting a position or an orientation of the responding device. Based on an adjustment (e.g., location and/or orientation adjustment information) determined by the initiating device based on preview images received from the responding device, the initiating device may transmit an instruction or notification to the responding device including the adjustment information, which describes how a position, orientation, or camera setting of the responding device should be manually or automatically adjusted. In some embodiments, the instruction may be configured to cause indicators to be displayed on an interface of the responding device to guide a user to adjust the responding device accordingly. In some embodiments, the instruction may be configured to automatically adjust a camera setting (e.g., focus, zoom, flash, etc.) of the responding device.

In block 3904, the processor may perform operations including transmitting, to the responding device, a second instruction configured to enable the responding device to capture a second image at approximately the same time as the initiating device captures a first image. The processes described in block 3904 may be performed after the initiating device determines that no further adjustments to the responding device are needed, such that the responding device is in a “ready” status to begin image capture. For example, the initiating device may transmit the second instruction in response to determining that the determined adjustment is within the acceptable threshold range for conducting simultaneous multi-viewpoint photography.

The second instruction may include configuration information to implement one or more various methods for synchronous image capture. In some embodiments, the initiating device may store a first time value when the first image is captured. The second instruction may include this first time value. The second image, or the image captured by the responding device as a result of implementing or otherwise being configured by the second instruction received from the initiating device, may be associated with a second time value corresponding to when the second image is captured. The second time value may be approximate to the first time value. For example, the instruction transmitted by the initiating device may include the time (e.g., timestamp) at which the image was captured by the initiating device, The responding device may use this time value associated with the initiating device captured image to determine which of any images captured in a cyclic buffer of the responding device have timestamps closest to the timestamp of the image captured by the initiating device.

In some embodiments, the instruction may include an initiate time value corresponding to the time that a user-initiated image capture (e.g., as described with reference to operation 450 of FIG. 4). In some embodiments, the initiate time value may be based on the time synchronization values received by the initiating device and the responding device, such as GNSS time signals (e.g., as described with reference to communications 416 and 418 of FIG. 4). The time synchronization values, as stored on the initiating device and the responding device, may be used to identify and correlate images captured and stored within cyclic buffers within each device. In some embodiments, the initiate time value may be based at least on a local clock frequency of the initiating device.

In some embodiments, the instruction transmitted by the initiating device may include configuration information to automatically initiate the generation of an analog signal for purposes of synching image capture. For example, the second instruction may be further configured to enable the responding device to generate a camera flash and capture the second image at approximately the same time as the initiating device generates a camera flash and captures the first image. An analog signal may be generated and output by the initiating device to initiate image capture. For example, the initiating device may generate a flash via the camera flash or an audio frequency “chirp” via speakers to instruct the responding device to begin image capture automatically. The responding device may be capable of detecting a flash or audio frequency “chirp” generated by the initiating device, and may begin the process to capture at least one image. In some embodiments, a test analog signal may be generated to determine the time between generation of the analog signal and the time upon which the responding device detects the analog signal. The determined analog latency value may be used to offset when the responding device may begin generating a camera flash for purposes of image capture and/or when the responding device begins image capture.

In some embodiments, the instruction transmitted by the initiating device may include a delay value. The responding device may be configured to display an indication to initiate or otherwise automatically initiate image capture after the duration of the delay value has passed. A delay value may reduce the amount of electronic storage used when capturing more than one image in a cyclic buffer, such that proceeding to capture images after a certain delay value may be closer to the point in time in which the initiating device begins capturing at least one image. The delay value may be based at least on a latency between the initiating device and the responding device (e.g., BLE communications latency), where the latency is caused by wireless communications protocols and handshaking and physical distance separating the devices. A delay value may include additional delay time in embodiments involving more than one responding device, such that each responding device may have a different latency value for communications with the initiating device. For example, the delay value may be equal to at least the time value of the largest latency value among the involved responding devices. Thus, the automatic capture of images by each responding device may be offset by at least the difference between their individual time delays and the largest latency value among the responding devices.

In some embodiments, the instruction transmitted by the initiating device to begin image capture may include a command to be executed by the responding device, such as to display an indication on the user interface display of the responding device to instruct the user to initiate image capture manually.

In block 3906, the processor may perform operations including capturing the first image. After performing operations as described in block 3904 to initiate image capture, the initiating device may capture one or more images. In some examples, capturing one or more images may be initiated at least after a time delay according to various embodiments.

In block 3908, the processor may perform operations including receiving, from the responding device, the second image. The initiating device may receive one or more images from the responding device associated with an image captured by the initiating device as described in block 3906. The one or more images received from the responding device may have timestamps approximate to the timestamps of any image captured by the initiating device.

In block 3910, the processor may perform operations including generating an image file based on the first image and the second image. Depending on the image capture mode (e.g., 3D, panoramic, blur or time lapse, multi-viewpoint, 360-degree 3D, and 360-degree panoramic mode), the generated image file may have different stylistic and/or perspective effects. In some embodiments in which an initiating device, responding device, and any other responding devices each capture multiple images in a sequence or burst fashion, the plurality of images may be used to generate a time-lapse image file, or a video file. In some examples, the first image, the second image, and any additional images taken by the initiating device, the responding device, and any other responding devices may be uploaded to a server for image processing and generation of the image file. This may save battery life and resources for the initiating device.

In some embodiments, the processor may perform operations including capturing a third image, storing a third time value when the third image is captured, transmitting the third time value to the responding device, receiving, from the responding device, a fourth image corresponding to the third time value, and generating the multi-image file based on the third image and the fourth image received from responding device.

FIG. 40 is a process flow diagram illustrating alternative operations 4000 that may be performed by a processor (e.g., processor 210, 212, 214, 216, 218, 252, 260, 322) of a wireless device (e.g., the wireless device 120a-120e, 200, 320, 402, 404) as part of the method 3900 for performing synchronous multi-viewpoint photography according to some embodiments.

Referring to FIG. 40, in some embodiments during or after the performance of block 3904 of the method 3900 (FIG. 39), the processor may perform operations described in blocks 4002 through 4004. For example, in block 4002, the processor may perform operations including transmitting a second instruction configured to enable the responding device to capture a second image at approximately the same time as the initiating device captures a first image by performing the operations as described with respect to block 4004.

In block 4004, the processor may perform operations including transmitting an instruction to start one of a countdown timer or a count up timer in the responding device at a same time as a similar count down or count up timer is started in the initiating device. The instruction may include information to configure or inform the responding device to capture the second image upon expiration of the countdown timer or upon the count up timer reaching a defined value. For example, the countdown timer or count up timer may be based at least on determining a communication delay between the initiating device and the responding device, such that the countdown timer or count up timer are of a time value greater than or equal to the delay. A count up timer or countdown timer may be based at least on a delay as determined by various embodiments.

The processor may then perform the operations of block 3906 of the method 3900 (FIG. 39) as described.

FIG. 41 is a process flow diagram illustrating alternative operations 4100 that may be performed by a processor (e.g., processor 210, 212, 214, 216, 218, 252, 260, 322) of a wireless device (e.g., the wireless device 120a-120e, 200, 320, 402, 404) as part of the method 3900 for performing synchronous multi-viewpoint photography according to some embodiments.

Referring to FIG. 41, in some embodiments during or after the performance of block 3904, 3906, and 3908 of the method 3900 (FIG. 39), the processor may perform operations described in blocks 4102 through 4106.

In block 4102, the processor may perform operations including transmitting a second instruction configured to enable the responding device to capture a second image at approximately the same time as the initiating device captures a first image by instructing the responding device to capture a plurality of images and recording a time when each image is captured.

In block 4104, the processor may perform operations including capturing the first image by capturing the first image and recording a time when the first image was captured.

In block 4106, the processor may perform operations including receiving the second image by transmitting, to the responding device, the time when the first image was captured and receiving the second image in response, wherein the second image is one of the plurality of images that was captured by the responding device at approximately the time when the first image was captured.

The processor may then perform the operations of block 3910 of the method 3900 (FIG. 39) as described.

FIG. 42 is a process flow diagram illustrating alternative operations 4200 that may be performed by a processor (e.g., processor 210, 212, 214, 216, 218, 252, 260, 322) of a wireless device (e.g., the wireless device 120a-120e, 200, 320, 402, 404) as part of the method 3900 for performing synchronous multi-viewpoint photography according to some embodiments.

Referring to FIG. 42, in some embodiments during or after the performance of block 3904 of the method 3900 (FIG. 39), the processor may perform operations described in blocks 4202 through 4206. For example, in block 4202, the processor may perform operations including transmitting a second instruction configured to enable the responding device to capture a second image at approximately the same time as the initiating device captures a first image by performing the operations as described with respect to blocks 4204 and 4206.

In block 4204, the processor may perform operations including transmitting a timing signal that enables synchronizing a clock in the initiating device with a clock in the responding device. The initiating device may transmit the timing signal to the responding device for synchronization purposes. In some embodiments, the initiating device may transmit, alternatively or in addition to the time signal, an instruction to configure the responding device to request or retrieve the timing signal from a source in which the initiating device received the timing signal. For example, the initiating device may transmit an instruction to configure the responding device to request a timing signal from the same GNSS that the initiating device received the timing signal. The timing signal may be a server referenced clock signal, a GNSS timing or clock signal, a local clock (e.g., crystal oscillator clock) of the initiating device, or any other timing signal as described by various embodiments.

In block 4206, the processor may perform operations including transmitting a time based on the synchronized clocks at which the first and second images will be captured. The initiating device can store a time value for each image captured by the initiating device. The time value may be used to reference and retrieve images captured by the responding device for purposes of synchronous multi-viewpoint image capture as described by embodiments.

The processor may then perform the operations of block 3906 of the method 3900 (FIG. 39) as described.

FIG. 43 is a process flow diagram illustrating alternative operations 4300 that may be performed by a processor (e.g., processor 210, 212, 214, 216, 218, 252, 260, 322) of a wireless device (e.g., the wireless device 120a-120e, 200, 320, 402, 404) as part of the method 3900 for performing synchronous multi-viewpoint photography according to some embodiments.

Prior to the performance of the operations of block 3902 of the method 3900 (FIG. 39), the processor may perform operations including receiving a time signal from a global positioning system (GPS) in block 4302. The initiating device may receive a time signal from a GNSS receiver for use in creating and referencing timestamped images as described in embodiments. In some embodiments, the initiating device may receive or request the time signal from a GNSS receiver in response to determining that a user of the initiating device has initiated an application or process to performing synchronous multi-viewpoint image capture. In some examples, transmitting the second instruction configured to enable the responding device to capture a second image at approximately the same time as the initiating device captures a first image includes indicating a time based on GNSS time signals at which the responding device should capture the second image.

The processor may then perform the operations of block 3902 of the method 3900 (FIG. 39) as described.

FIG. 44 is a process flow diagram illustrating alternative operations 4400 that may be performed by a processor (e.g., processor 210, 212, 214, 216, 218, 252, 260, 322) of a wireless device (e.g., the wireless device 120a-120e, 200, 320, 402, 404) as part of the method 3900 for performing synchronous multi-viewpoint photography according to some embodiments.

Following the performance of the operations of block 3904 of the method 3900 (FIG. 39), the processor may perform operations including generating an analog signal configured to enable the responding device to capture the second image at approximately the same time as the initiating device captures the first image in block 4402. In some embodiments, the analog signal may be a camera flash or an audio frequency signal. In some embodiments, capturing the first image may be performed a predefined time after generating the analog signal.

In some embodiments, an analog signal may be generated and output by the initiating device to initiate image capture. For example, the initiating device may generate a flash via the camera flash or an audio frequency “chirp” via speakers to instruct the responding device to begin image capture automatically. The responding device may be capable of detecting a flash or audio frequency “chirp” generated by the initiating device, and may begin the process to capture at least one image a predefined or configurable time after detecting the analog signal. In some embodiments, a test analog signal may be generated to determine the time between generation of the analog signal and the time upon which the responding device detects the analog signal. The determined analog latency value may be used to offset when the responding device may begin generating a camera flash for purposes of image capture and/or when the responding device begins image capture. The predefined time may be based at least on the determined analog latency value.

The processor may then perform the operations of block 3906 of the method 3900 (FIG. 39) as described.

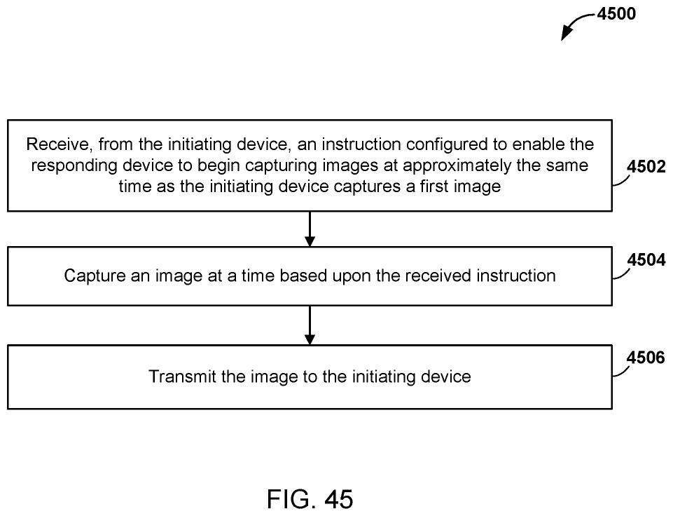

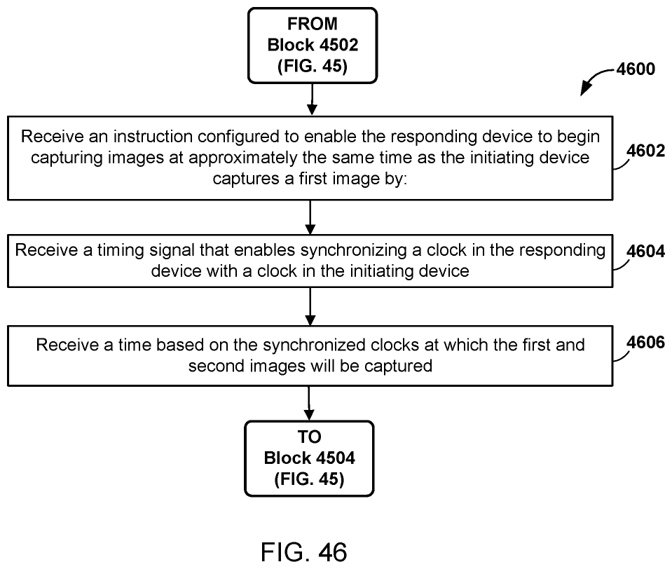

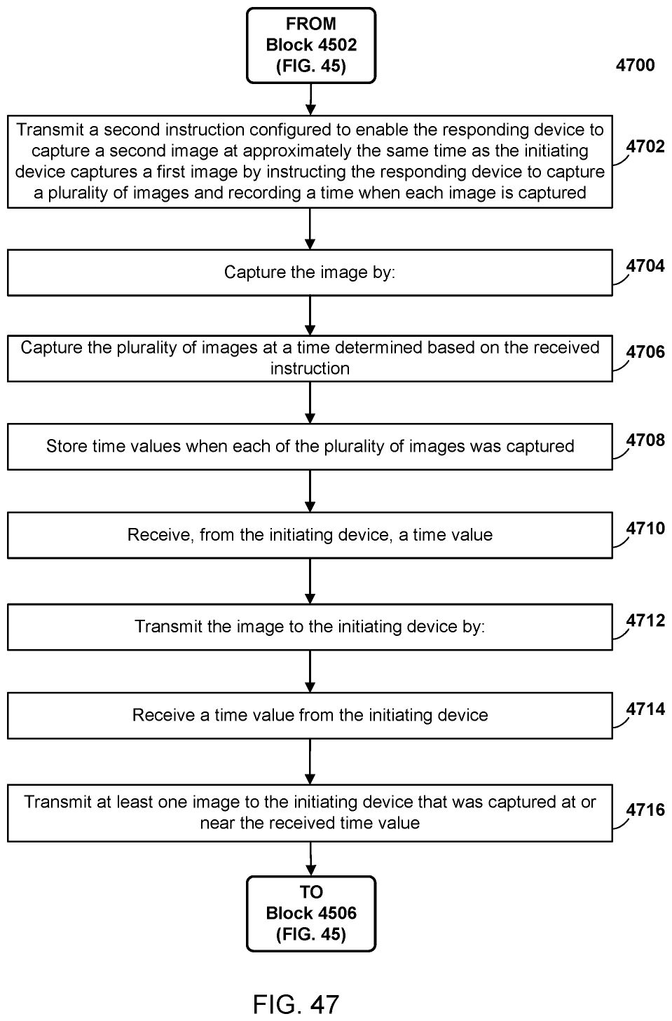

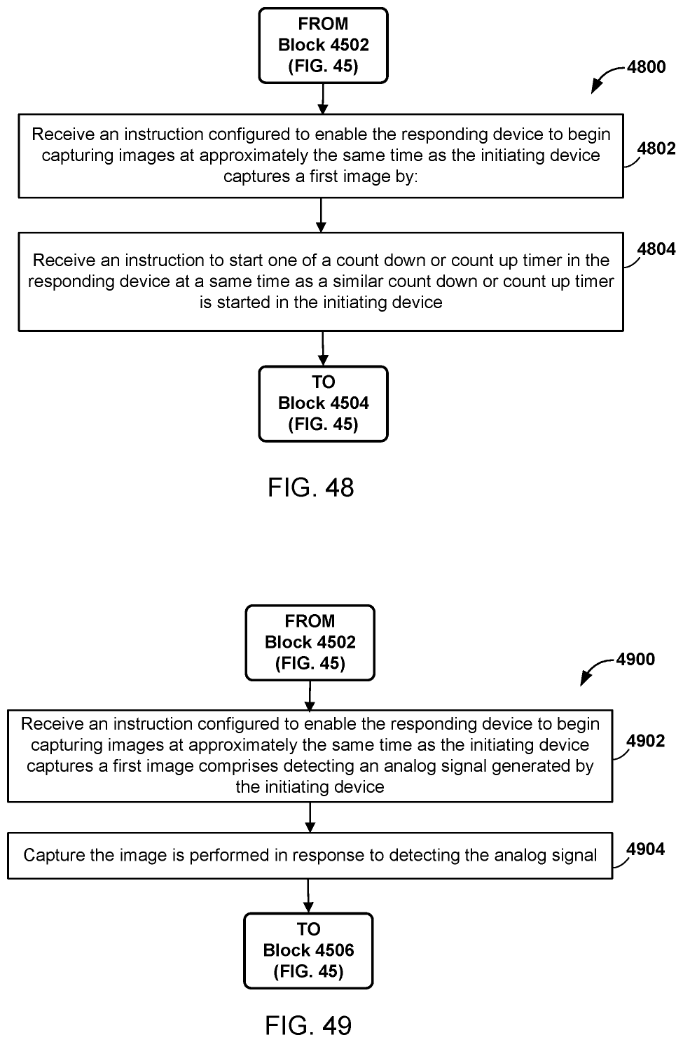

FIG. 45 is a process flow diagram illustrating a method 4500 implementing a responding device to perform synchronous multi-viewpoint photography according to various embodiments. With reference to FIGS. 1-45, the operations of the method 4500 may be performed by a processor (e.g., processor 210, 212, 214, 216, 218, 252, 260, 322) of a wireless device (e.g., the wireless device 120a-120e, 200, 320, 402, 404).

The order of operations performed in blocks 4502 through 4506 is merely illustrative, and the operations of blocks 4502-4505 may be performed in any order and partially simultaneously in some embodiments. In some embodiments, the method 4500 may be performed by a processor of an initiating device independently from, but in conjunction with, a processor of a responding device. For example, the method 4500 may be implemented as a software module executing within a processor of an SoC or in dedicated hardware within an SoC that monitors data and commands from/within the server and is configured to take actions and store data as described. For ease of reference, the various elements performing the operations of the method 4500 are referred to in the following method descriptions as a “processor.”

In block 4502, the processor may perform operations including receiving, from an initiating device, an instruction configured to enable the responding device to capture an image at approximately the same time as the initiating device captures a first image. The processes described in block 3710 may be performed after the initiating device determines that no further adjustments to the responding device are needed, such that the responding device is in a “ready” status to begin image capture. For example, the responding device may receive the instruction in response to the initiating device determining that the position, orientation, and/or camera settings of the responding device, as determined from the second preview image, are within an acceptable threshold range defined by the received location and/or orientation adjustment information.

The instruction may include configuration information to implement one or more various methods for synchronous image capture. In some embodiments, the responding device, as part of the instruction, may receive a time value for when the initiating device captures an image. In some embodiments, the time value may be received by the responding device as part of a separate instruction after receiving the initial instruction configured to enable the responding device to capture at least one image.

The image captured by the responding device as a result of implementing or otherwise being configured by the instruction received from the initiating device may be associated with one or more time values corresponding to when the responding device captures one or more images. The time values associated with any images captured by the responding device may be approximate to the time identified by the initiating device. For example, the instruction received by the responding device may include the time (e.g., timestamp) at which the image was captured by the initiating device. The responding device may use this identified time value associated with the initiating device captured image to determine which of any images captured in a cyclic buffer of the responding device have timestamps closest to the timestamp of the image captured by the initiating device.

In some embodiments, the responding device, as part of the instruction or in addition to the instruction received in block 4502, may receive an instruction or information to capture an image at a time based upon a GNSS time signal.

In block 4504, the processor may perform operations including capturing an image at a time based upon the received instruction. After performing operations as described in block 4502 to initiate image capture, the responding device may capture one or more images. In some examples, capturing one or more images may be initiated at least after a time delay according to various embodiments. If multiple images are captures in a series or burst fashion, the images may be stored within a cyclic buffer that may be referenced by timestamps corresponding to the time at which the images were captured by the camera of the responding device.

In block 4506, the processor may perform operations including transmitting the image to the initiating device. The responding device may transmit one or more images from the responding device associated with an image captured by the initiating device. The one or more images transmitted by the responding device may have timestamps approximate to the timestamps of any image captured by the initiating device.

FIG. 46 is a process flow diagram illustrating alternative operations 4600 that may be performed by a processor (e.g., processor 210, 212, 214, 216, 218, 252, 260, 322) of a wireless device (e.g., the wireless device 120a-120e, 200, 320, 402, 404) as part of the method 4500 for performing synchronous multi-viewpoint photography according to some embodiments.

Referring to FIG. 46, in some embodiments during or after the performance of block 4502 of the method 4500 (FIG. 45), the processor may perform operations described in blocks 4602 through 4606. For example, in block 4602, the processor may perform operations including receiving an instruction configured to enable the responding device to capture an image at approximately the same time as the initiating device captures a first image by performing the operations as described with respect to blocks 4604 and 4606.

In block 4604, the processor may perform operations including receiving a timing signal that enables synchronizing a clock in the responding device with a clock in the initiating device. The responding device may receive the timing signal from the initiating device for synchronization purposes. In some embodiments, the responding device may receive, alternatively or in addition to the time signal, the instruction to configure the responding device to request or retrieve the timing signal from a source in which the initiating device received the timing signal. For example, the responding device may receive an instruction to configure the responding device to use a timing signal from the same GNSS that the initiating device received. The timing signal may be a server referenced clock signal, a GNSS timing or clock signal, a local clock (e.g., crystal oscillator clock) of the initiating device, or any other timing signal as described by various embodiments.

In block 4606, the processor may perform operations including receiving a time based on the synchronized clocks at which the first and second images will be captured. The initiating device may store a time value for each image captured by the initiating device. The responding device may receive the time values for each image that the initiating devices captures. The time values may be used to reference and retrieve images captured by the responding device for purposes of synchronous multi-viewpoint image capture as described by embodiments. In some embodiments, capturing the image via the camera of the responding device at a time based upon the received instruction comprises capturing the image at the received time based on the synchronized clock.

The processor may then perform the operations of block 4504 of the method 4500 (FIG. 45) as described.

FIG. 47 is a process flow diagram illustrating alternative operations 4700 that may be performed by a processor (e.g., processor 210, 212, 214, 216, 218, 252, 260, 322) of a wireless device (e.g., the wireless device 120a-120e, 200, 320, 402, 404) as part of the method 4500 for performing synchronous multi-viewpoint photography according to some embodiments.

Referring to FIG. 47, in some embodiments during or after the performance of blocks 4502, 4504, and 4506 of the method 4500 (FIG. 45), the processor may perform operations described in blocks 4702 through 4716.

In block 4702, the processor may perform operations including receiving an instruction configured to enable the responding device to capture an image at approximately the same time as the initiating device captures a first image comprises receiving an instruction to capture a plurality of images and recording a time when each image is captured.

In block 4704, the processor may perform operations including capturing the image.

In block 4706 the processor may perform operations including capturing the plurality of images at a time determined based on the received instruction. The responding device may capture multiple images in response to receiving the instruction as described in block 4702.

In block 4708 the processor may perform operations including storing time values when each of the plurality of images was captured. Each image captured by the camera of the responding device may be associated with a time value or a timestamp based on a synchronous clock signal.

In block 4710, the processor may perform operations including receiving a time value from the initiating device.

In block 4712, the processor may perform operations including transmitting the image to the initiating device.

In block 4714, the processor may perform operations including receiving a time value from the initiating device.

In block 4716, the processor may perform operations including transmitting at least one image to the initiating device that was captured at or near the received time value.

The processor may then perform the operations of block 4506 of the method 4500 (FIG. 45) as described.

FIG. 48 is a process flow diagram illustrating alternative operations 4800 that may be performed by a processor (e.g., processor 210, 212, 214, 216, 218, 252, 260, 322) of a wireless device (e.g., the wireless device 120a-120e, 200, 320, 402, 404) as part of the method 4500 for performing synchronous multi-viewpoint photography according to some embodiments.

Referring to FIG. 48, in some embodiments during or after the performance of block 4502 of the method 4500 (FIG. 45), the processor may perform operations described in blocks 4802 through 4804. For example, in block 4802, the processor may perform operations including receiving an instruction configured to enable the responding device to capture an image at approximately the same time as the initiating device captures a first image by performing the operations as described with respect to block 4804.

In block 4804, the processor may perform operations including receiving an instruction to start one of a countdown timer or a count up timer in the responding device at a same time as a similar count down or count up timer is started in the initiating device. The instruction may include information to configure or inform the responding device to capture the second image upon expiration of the countdown timer or upon the count up timer reaching a defined value. For example, the countdown timer or count up timer may be based at least on determining a communication delay between the initiating device and the responding device, such that the countdown timer or count up timer are of a time value greater than or equal to the delay. A count up timer or countdown timer may be based at least on a delay as determined by various embodiments.

The processor may then perform the operations of block 4504 of the method 4500 (FIG. 45) as described.

FIG. 49 is a process flow diagram illustrating alternative operations 4900 that may be performed by a processor (e.g., processor 210, 212, 214, 216, 218, 252, 260, 322) of a wireless device (e.g., the wireless device 120a-120e, 200, 320, 402, 404) as part of the method 4500 for performing synchronous multi-viewpoint photography according to some embodiments.

Following the performance of the operations of block 4502 of the method 4500 (FIG. 45), the processor may perform operations including receiving an instruction configured to enable the responding device to capture an image at approximately the same time as the initiating device captures a first image by detecting an analog signal generated by the initiating device in block 4902. In some embodiments, the analog signal may be a camera flash or an audio frequency signal.

In block 4904, the processor may perform operations including capturing the image is performed in response to detecting the analog signal. In some embodiments, capturing the image may be performed a predefined time after detecting the analog signal.

In some embodiments, an analog signal may be detected by the responding device to initiate image capture. The responding device may be capable of detecting a flash or audio frequency “chirp” generated by the initiating device, and may begin the process to capture at least one image a predefined or configurable time after detecting the analog signal. In some embodiments, a test analog signal may be detected by the responding device to determine the time between generation of the analog signal and the time upon which the responding device detects the analog signal. The determined analog latency value may be used to offset when the responding device may begin image capture after detecting a camera flash or audio signal. The predefined time may be based at least on the determined analog latency value.

In some embodiments, receiving an instruction configured to enable the responding device to capture an image at approximately the same time as the initiating device captures a first image may include an instruction configured to enable the responding device to generate an illumination flash at approximately the same time as the initiating device generates an illumination flash. For example, an illumination flash may be generated by the initiating device and the responding device may begin image capture some time after detecting the illumination flash based upon the instruction when capturing the image.

The processor may then perform the operations of block 4506 of the method 4500 (FIG. 45) as described.

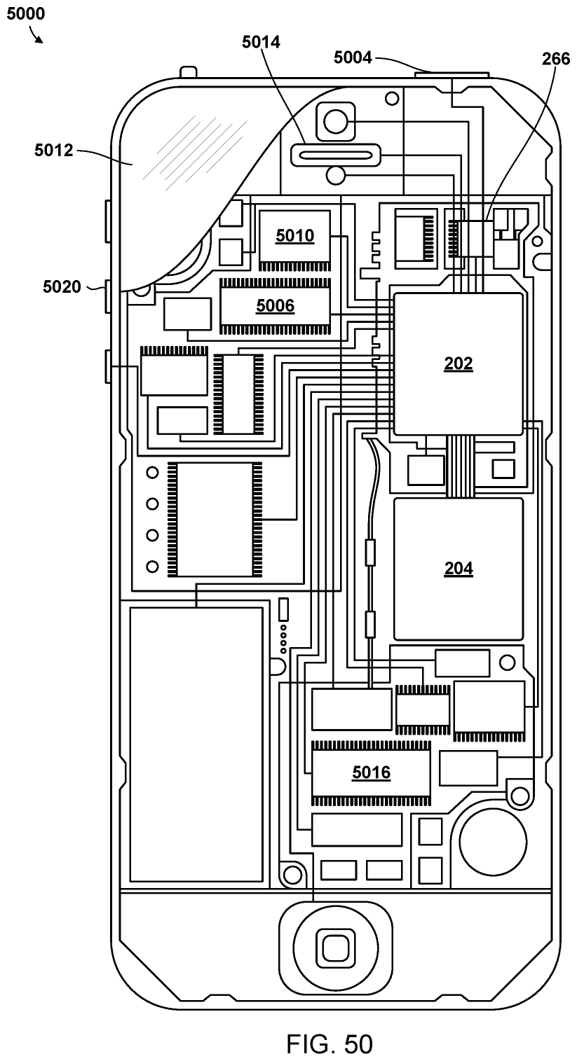

FIG. 50 is a component block diagram of an example wireless device in the form of a smartphone 5000 suitable for implementing some embodiments. With reference to FIGS. 1-50, a smartphone 5000 may include a first SOC 202 (such as a SOC-CPU) coupled to a second SOC 204 (such as a 5G capable SOC). The first and second SOCs 202, 204 may be coupled to internal electronic storage (i.e. memory) 5006, 5016, a display 5012, and a speaker 5014. Additionally, the smartphone 5000 may include an antenna 5004 for sending and receiving electromagnetic radiation that may be connected to a wireless data link or cellular telephone transceiver 266 coupled to one or more processors in the first or second SOCs 202, 204. Smartphones 5000 typically also include menu selection buttons or rocker switches 5020 for receiving user inputs.

A typical smartphone 5000 also includes a sound encoding/decoding (CODEC) circuit 5010, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 5010 may include a digital signal processor (DSP) circuit (not shown separately).

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A method performed by a processor of an initiating device for synchronous multipoint photography comprising:
transmitting, to a responding device, a first instruction configured to enable the responding device to display a notification for adjusting a position or an orientation of the responding device;
transmitting, to the responding device, a second instruction configured to enable the responding device to capture a second image at approximately the same time as the initiating device captures a first image;
capturing the first image;
receiving, from the responding device, the second image; and
generating an image file based on the first image and the second image.

2. The method of claim 1, wherein transmitting a second instruction configured to enable the responding device to capture a second image at approximately the same time as the initiating device captures a first image comprises:
transmitting a timing signal that enables synchronizing a clock in the initiating device with a clock in the responding device; and
transmitting a time based on the synchronized clocks at which the first and second images will be captured.

3. The method of claim 2, wherein:
transmitting a second instruction configured to enable the responding device to capture a second image at approximately the same time as the initiating device captures a first image comprises instructing the responding device to capture a plurality of images and recording a time when each image is captured;
capturing the first image comprises capturing the first image and recording a time when the first image was captured;
receiving the second image comprises transmitting, to the responding device, the time when the first image was captured and receiving the second image in response, wherein the second image is one of the plurality of images that was captured by the responding device at approximately the time when the first image was captured.

4. The method of claim 1, wherein transmitting a second instruction configured to enable the responding device to capture a second image at approximately the same time as the initiating device captures a first image comprises:
transmitting an instruction to start one of a countdown timer or a count up timer in the responding device at a same time as a similar count down or count up timer is started in the initiating device, wherein the instruction informs the responding device to capture the second image upon expiration of the countdown timer or upon the count up timer reaching a defined value,
wherein capturing the first image is performed upon expiration of the countdown timer or upon the count up timer reaching the defined value.

5. The method of claim 1, further comprising:
receiving a time signal from a global positioning system (GPS),
wherein transmitting the second instruction configured to enable the responding device to capture a second image at approximately the same time as the initiating device captures a first image comprises indicating a time based on GPS time signals at which the responding device should capture the second image.

6. The method of claim 1, further comprising:
capturing a third image;
storing a third time value when the third image is captured;
transmitting the third time value to the responding device;
receiving, from the responding device, a fourth image corresponding to the third time value; and
generating the image file based on the third image and the fourth image received from responding device.

7. The method of claim 1, further comprising:
generating an analog signal configured to enable the responding device to capture the second image at approximately the same time as the initiating device captures the first image, wherein the analog signal is a camera flash or an audio frequency signal,
wherein capturing the first image is performed a predefined time after generating the analog signal.

8. The method of claim 1, wherein the second instruction is further configured to enable the responding device to generate a camera flash and capture the second image at approximately the same time as the initiating device generates a camera flash and captures the first image.

9. A wireless device, comprising:
a camera;
a wireless transceiver configured to establish a wireless communication link with responding devices;
a user interface display; and
a processor coupled to the camera, the wireless transceiver and the user interface display, and configured with processor-executable instructions to:
transmit, to a responding device, a first instruction configured to enable the responding device to display a notification for adjusting a position or an orientation of the responding device;
transmit, to the responding device, a second instruction configured to enable the responding device to capture a second image at approximately the same time as the wireless device captures a first image;
capture the first image;
receive, from the responding device, the second image; and
generate an image file based on the first image and the second image.

10. The wireless device of claim 9, wherein the processor is further configured with processor-executable instructions to transmit a second instruction configured to enable the responding device to capture a second image at approximately the same time as the wireless device captures a first image by:
identifying a point of interest in the first preview image;
performing image processing on the second preview image to identify the point of interest in the second preview image;
determining a first perceived size of the identified point of interest in the first preview image;
determining a second perceived size of the identified point of interest in the second preview image;
calculating a perceived size difference by between the first perceived size and the second perceived size; and
determining the adjustment transmitted to the responding wireless device based at least on the perceived size difference.

11. The wireless device of claim 9, wherein the processor is further configured with processor-executable instructions to:
transmit a second instruction configured to enable the responding device to capture a second image at approximately the same time as the wireless device captures a first image by instructing the responding device to capture a plurality of images and recording a time when each image is captured;
record a time when the first image was captured;
receive the second image by transmitting, to the responding device, the time when the first image was captured and receiving the second image in response, wherein the second image is one of the plurality of images that was captured by the responding device at approximately the time when the first image was captured.

12. The wireless device of claim 9, wherein the processor is further configured with processor-executable instructions to:
transmit a second instruction configured to enable the responding device to capture a second image at approximately the same time as the wireless device captures a first image by transmitting an instruction to start one of a countdown timer or a count up timer in the responding device at a same time as a similar count down or count up timer is started in the wireless device, wherein the instruction informs the responding device to capture the second image upon expiration of the countdown timer or upon the count up timer reaching a defined value; and
capture the first image in response to expiration of the countdown timer or the count up timer reaching the defined value.

13. The wireless device of claim 9, wherein the processor is further configured with processor-executable instructions to:
receive a time signal from a global positioning system (GPS); and
transmit the second instruction configured to enable the responding device to capture a second image at approximately the same time as the wireless device captures a first image by indicating a time based on GPS time signals at which the responding device should capture the second image.

14. The wireless device of claim 9, wherein the processor is further configured with processor-executable instructions to:
capture a third image;
store a third time value when the third image is captured;
transmit the third time value to the responding device;
receive, from the responding device, a fourth image corresponding to the third time value; and
generate the image file based on the third image and the fourth image received from responding device.

15. The wireless device of claim 9, wherein the processor is further configured with processor-executable instructions to:
generate an analog signal configured to enable the responding device to capture the second image at approximately the same time as the wireless device captures the first image, wherein the analog signal is a camera flash or an audio frequency signal,
capture the first image a predefined time after generating the analog signal.

16. The wireless device of claim 9, wherein the second instruction is further configured to enable the responding device to generate a camera flash and capture the second image at approximately the same time as the wireless device generates a camera flash and captures the first image.

17. A method performed by a processor of a responding device for synchronous multipoint photography comprising:
receiving, from an initiating device, an instruction configured to enable the responding device to capture an image at approximately the same time as the initiating device captures a first image;
capturing an image at a time based upon the received instruction; and
transmitting the image to the initiating device.

18. The method of claim 17, wherein receiving an instruction configured to enable the responding device to capture an image at approximately the same time as the initiating device captures a first image comprises:
receiving a timing signal that enables synchronizing a clock in the responding device with a clock in the initiating device; and
receiving a time based on the synchronized clocks at which the first and second images will be captured,
wherein capturing the image at a time based upon the received instruction comprises capturing the image at the received time based on the synchronized clock.

19. The method of claim 17, wherein:
receiving an instruction configured to enable the responding device to capture an image at approximately the same time as the initiating device captures a first image comprises receiving an instruction to capture a plurality of images and recording a time when each image is captured;
capturing the image comprises:
capturing the plurality of images at a time determined based on the received instruction; and
storing time values when each of the plurality of images was captured; and
transmitting the image to the initiating device comprises:
receiving a time value from the initiating device; and
transmitting at least one image to the initiating device that was captured at or near the received time value.

20. The method of claim 17, wherein receiving an instruction configured to enable the responding device to capture an image at approximately the same time as the initiating device captures a first image comprises:
receiving an instruction to start one of a countdown timer or a count up timer in the responding device at a same time as a similar count down or count up timer is started in the initiating device,
wherein capturing the image is performed upon expiration of the countdown timer or upon the count up timer reaching a defined value.

21. The method of claim 17, wherein receiving an instruction configured to enable the responding device to capture an image at approximately the same time as the initiating device captures a first image comprises:
receiving an instruction to capture the image at a time based upon a GPS time signal.

22. The method of claim 17, wherein:
receiving an instruction configured to enable the responding device to capture an image at approximately the same time as the initiating device captures a first image comprises detecting an analog signal generated by the initiating device, wherein the analog signal is a camera flash or an audio frequency signal; and
capturing the image is performed in response to detecting the analog signal.

23. The method of claim 17, wherein receiving an instruction configured to enable the responding device to capture an image at approximately the same time as the initiating device captures a first image comprises receiving an instruction configured to enable the responding device to generate an illumination flash at approximately the same time as the initiating device generates an illumination flash, the method further comprising generating an illumination flash based upon the instruction when capturing the image.

24. A wireless device, comprising:
a camera;
a wireless transceiver configured to establish a wireless communication link with responding wireless devices;
a user interface display; and
a processor coupled to the camera, the wireless transceiver and the user interface display, and configured with processor-executable instructions to:
receive, from an initiating device, an instruction configured to enable the wireless device to capture an image at approximately the same time as the initiating device captures a first image;
capture an image at a time based upon the received instruction; and
transmit the image to the initiating device.

25. The wireless device of claim 24, wherein the processor is further configured with processor-executable instructions to receive an instruction configured to enable the wireless device to capture an image at approximately the same time as the initiating device captures a first image by:
receiving a timing signal that enables synchronizing a clock in the wireless device with a clock in the initiating device; and
receiving a time based on the synchronized clocks at which the first and second images will be captured,
wherein the processor is further configured with processor-executable instructions to capture the image at a time based upon the received instruction comprises capturing the image at the received time based on the synchronized clock.

26. The wireless device of claim 24, wherein the processor is further configured with processor-executable instructions to:
receive an instruction configured to enable the wireless device to capture an image at approximately the same time as the initiating device captures a first image by receiving an instruction to capture a plurality of images and recording a time when each image is captured;
capture the image by:
capturing the plurality of images at a time determined based on the received instruction; and
storing time values when each of the plurality of images was captured; and
transmitting the image to the initiating device by:
receiving a time value from the initiating device; and
transmitting at least one image to the initiating device that was captured at or near the received time value.

27. The wireless device of claim 24, wherein the processor is further configured with processor-executable instructions to:
receive an instruction configured to enable the responding device to capture an image at approximately the same time as the initiating device captures a first image by receiving an instruction to start one of a countdown timer or a count up timer in the responding device at a same time as a similar count down or count up timer is started in the initiating device; and
capture the image in response to expiration of the countdown timer or the count up timer reaching a defined value.

28. The wireless device of claim 24, wherein the processor is further configured with processor-executable instructions to receive an instruction configured to enable the responding device to capture an image at approximately the same time as the initiating device captures a first image by receiving an instruction to capture the image at a time based upon a GPS time signal.

29. The wireless device of claim 24, wherein the processor is further configured with processor-executable instructions to:
receive an instruction configured to enable the responding device to capture an image at approximately the same time as the initiating device captures a first image comprises detecting an analog signal generated by the initiating device, wherein the analog signal is a camera flash or an audio frequency signal; and
capture the image is performed in response to detecting the analog signal.

30. The wireless device of claim 24, wherein the processor is further configured with processor-executable instructions to receive an instruction configured to enable the responding device to capture an image at approximately the same time as the initiating device captures a first image by receiving an instruction configured to enable the responding device to generate an illumination flash at approximately the same time as the initiating device generates an illumination flash, the method further comprising generating an illumination flash based upon the instruction when capturing the image.
